(19) United States
(12) Patent Application Publication
(10) Pub. No.: US 2024/0127116 A1
(43) Pub. Date: Apr. 18, 2024

(54) FEDERATED LEARNING APPARATUS, SERVER APPARATUS, FEDERATED LEARNING SYSTEM, FEDERATED LEARNING METHOD, AND RECORDING MEDIUM

(71) Applicant: NEC Corporation, Tokyo (JP)

(72) Inventor: Isamu TERANISHI, Tokyo (JP)

(73) Assignee: NEC Corporation, Tokyo (JP)

(21) Appl. No.: 18/374,812

(22) Filed: Sep. 29, 2023

(30) Foreign Application Priority Data
Oct. 7, 2022 (JP) 2022-162746

(51) Int. Cl. G06N 20/00

(52) U.S. Cl. CPC G06N 20/00

(57) ABSTRACT

To generate information appropriate for a receiver of the information, a federated learning apparatus includes: a training section which trains a first prediction model that predicts an evaluation value corresponding to a combination of a user and an evaluation target on which the evaluation value is not obtained, using a first training data set including (i) evaluation values of users on evaluation targets and (ii) attribute values of the evaluation targets; a parameter information transmitting section which transmits, to a server apparatus, first parameter information indicating the first prediction model; a parameter information obtaining section which obtains, from the server apparatus, integrated parameter information obtained by integrating the first parameter information and second parameter information indicating a second prediction model trained using a second training data set; and an updating section which updates the first prediction model by replacing the first parameter information with the integrated parameter information.

### CROSS REFERENCE TO RELATED APPLICATIONS

This application is based upon and claims the benefit of priority from Japanese patent application No. 2022-162746, filed on Oct. 7, 2022, the disclosure of which is incorporated herein in its entirety by reference.

### TECHNICAL FIELD

The present invention relates to a technique of conducting federated learning.

### BACKGROUND ART

There is known a technique of, in order to determine a commodity to be recommended to a user, predicting a user's interest in a commodity other than a commodity that the user purchased in the past, on the basis of, for example, a rate which the user gave to the commodity that the user purchased in the past.

Non-Patent Literature 1 discloses a technique of realizing such prediction with use of federated learning. Here, the federated learning is a technique of training a single prediction model with use of a training data set which is possessed by each of a plurality of clients. In the federated learning, the training data set possessed by each of the clients is not disclosed to the other of the clients. Therefore, the concealment of information is ensured. The technique disclosed in Non-Patent Literature 1 realizes collaborative filtering by the federated learning. Non-Patent Literature 2 discloses a technique of predicting a user's interest in consideration of a user attribute in addition to a rate and thereby recommending a commodity to the user.

### CITATION LIST

### Non-Patent Literature

[Non-patent Literature 1]
Muhammad Ammad-ud-din et. al., “FEDERATED COLLABORATIVE FILTERING FOR PRIVACY-PRESERVING PERSONALIZED RECOMMENDATION SYSTEM”, arXiv:1901.09888(cs), Submitted on 29 Jan. 2019

[Non-patent Literature 2]
Q. Nguyen and F. Ricci., “User preferences initialization and integration in critique based mobile recommender systems”, Artificial Intelligence in Mobile Systems, pp. 71-78, 2004.

### SUMMARY OF INVENTION

### Technical Problem

However, even in a case where the technique disclosed in each of Non-Patent Literatures 1 and 2 is used, it is impossible to generate information appropriate for a receiver of the information. This is because the accuracy of information selected by the technique disclosed in each of Non-Patent Literatures 1 and 2 is low.

An example object of the present invention is to provide a federated learning apparatus etc., each of which makes it possible to generate information appropriate for a receiver of the information.

### Solution to Problem

A federated learning apparatus in accordance with an example aspect of the present invention is a federated learning apparatus including at least one processor, the at least one processor carrying out: a training process of training a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list; a parameter information transmitting process of transmitting, to a server apparatus, first parameter information which indicates at least a part of the first prediction model; a parameter information obtaining process of obtaining, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and an updating process of updating the first prediction model by replacing the first parameter information with the integrated parameter information.

A server apparatus in accordance with an example aspect of the present invention is a server apparatus including at least one processor, the at least one processor carrying out: a parameter information obtaining process of obtaining a plurality of pieces of first parameter information from a respective plurality of federated learning apparatuses each of which functions as the above federated learning apparatus; an integrating process of generating integrated parameter information by integrating the plurality of pieces of first parameter information; and a parameter information transmitting process of transmitting the integrated parameter information to each of the plurality of federated learning apparatuses.

A federated learning system in accordance with an example aspect of the present invention is a federated learning system including: a plurality of federated learning apparatuses each of which functions as the above federated learning apparatus; and a server apparatus, the server apparatus including at least one processor, the at least one processor carrying out: a parameter information obtaining process of obtaining a plurality of pieces of first parameter information from the respective plurality of federated learning apparatuses each of which functions as the federated learning apparatus; an integrating process of generating integrated parameter information by integrating the plurality of pieces of first parameter information; and a parameter information transmitting process of transmitting the integrated parameter information to each of the plurality of federated learning apparatuses.

A federated learning method in accordance with an example aspect of the present invention is a federated learning method including: (a) training a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list; (b) transmitting, to a server apparatus, first parameter information which indicates at least a part of the first prediction model; (c) obtaining, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and (d) updating the first prediction model by replacing the first parameter information with the integrated parameter information, (a) through (d) being carried out by a computer.

A non-transitory recording medium in accordance with an example aspect of the present invention is a non-transitory recording medium in which a program for causing a computer to operate as the above federated learning apparatus is recorded, the program causing the computer to carry out the training process, the parameter information transmitting process, the parameter information obtaining process, and the updating process.

A federated learning method in accordance with an example aspect of the present invention is a federated learning method including: (a) training a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list; (b) transmitting, to a server apparatus, first parameter information which indicates at least a part of the first prediction model; (c) obtaining, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and (d) updating the first prediction model by replacing the first parameter information with the integrated parameter information, (a) through (d) being carried out by each of a plurality of federated learning apparatuses, the federated learning method further including: (e) obtaining a plurality of pieces of first parameter information from the respective plurality of federated learning apparatuses; (f) generating the integrated parameter information by integrating the plurality of pieces of first parameter information; and (g) transmitting the integrated parameter information to each of the plurality of federated learning apparatuses, (e) through (g) being carried out by the server apparatus.

### Advantageous Effects of Invention

According to an example aspect of the present invention, it is possible to generate information appropriate for a receiver of the information.

### BRIEF DESCRIPTION OF DRAWINGS

FIG. 1 is a block diagram illustrating a configuration of a federated learning apparatus in accordance with a first example embodiment of the present invention.

FIG. 2 is a flowchart illustrating a flow of a federated learning method in accordance with the first example embodiment of the present invention.

FIG. 3 is a block diagram illustrating a configuration of a server apparatus in accordance with a second example embodiment of the present invention.

FIG. 4 is a flowchart illustrating a flow of a federated learning method in accordance with the second example embodiment of the present invention.

FIG. 5 is a block diagram illustrating a configuration of a federated learning system in accordance with a third example embodiment of the present invention.

FIG. 6 is a flowchart illustrating a flow of a federated learning method in accordance with the third example embodiment of the present invention.

FIG. 7 is a block diagram illustrating a configuration of an entire federated learning system in accordance with a fourth example embodiment of the present invention.

FIG. 8 is a schematic view illustrating an outline of federated learning in accordance with the fourth example embodiment of the present invention.

FIG. 9 is a block diagram illustrating a functional configuration of a client apparatus in accordance with the fourth example embodiment of the present invention.

FIG. 10 is a block diagram illustrating a functional configuration of a server apparatus in accordance with the fourth example embodiment of the present invention.

FIG. 11 is a block diagram illustrating a functional configuration of a servicer apparatus in accordance with the fourth example embodiment of the present invention.

FIG. 12 is a flowchart illustrating a flow of an information processing method in accordance with the fourth example embodiment of the present invention.

FIG. 13 is a flowchart illustrating a flow of another information processing method in accordance with the fourth example embodiment of the present invention.

FIG. 14 is a flowchart illustrating a flow of further another information processing method in accordance with the fourth example embodiment of the present invention.

FIG. 15 is a flowchart illustrating a flow of further another information processing method in accordance with the fourth example embodiment of the present invention.

FIG. 16 is a flowchart illustrating a flow of further another information processing method in accordance with the fourth example embodiment of the present invention.

FIG. 17 is a flowchart illustrating a flow of further another information processing method in accordance with the fourth example embodiment of the present invention.

FIG. 18 is a flowchart illustrating a flow of a federated learning method in accordance with the fourth example embodiment of the present invention.

FIG. 19 is a flowchart illustrating a flow of a server initializing method in accordance with the fourth example embodiment of the present invention.

FIG. 20 is a flowchart illustrating a flow of a client initializing method in accordance with the fourth example embodiment of the present invention.

FIG. 21 is a flowchart illustrating a flow of a client learning method in accordance with the fourth example embodiment of the present invention.

FIG. 22 is a flowchart illustrating a flow of a server learning method in accordance with the fourth example embodiment of the present invention.

FIG. 23 is a view illustrating an example of a hardware configuration constituting each of the apparatuses in accordance with the example embodiments of the present invention.

### EXAMPLE EMBODIMENTS

In the following example embodiments, federated learning is a technique of training a single prediction model with use of a training data set which is possessed by each of a plurality of clients. In the federated learning, the training data set possessed by each of the clients is not disclosed to the other of the clients. Therefore, the concealment of information is ensured.

### First Example Embodiment

The following description will discuss, in detail, a first example embodiment of the present invention with reference to drawings. The present example embodiment is made the basis of second to fourth example embodiments described later.

(Configuration of Federated Learning Apparatus 1)

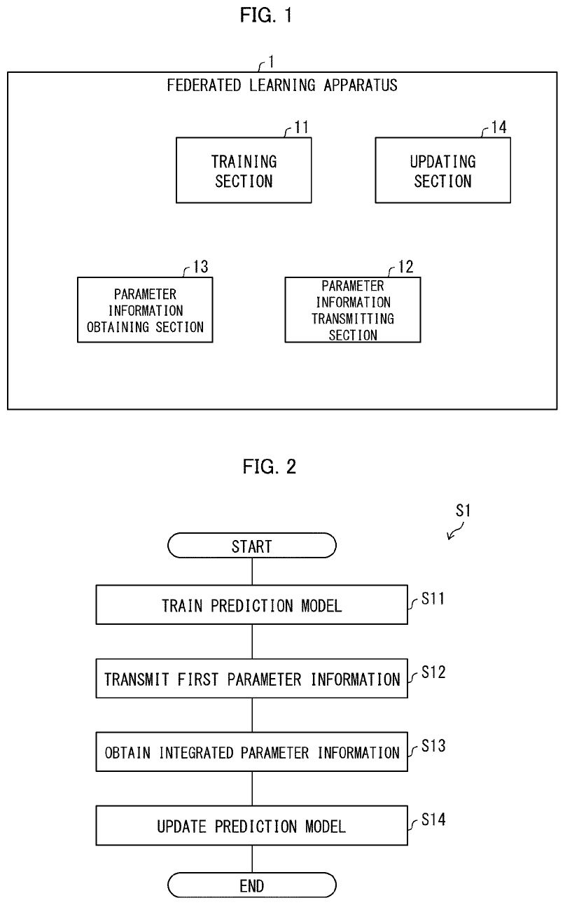

A configuration of a federated learning apparatus 1 in accordance with the present example embodiment is described with reference to FIG. 1. FIG. 1 is a block diagram illustrating the configuration of the federated learning apparatus 1. As illustrated in FIG. 1, the federated learning apparatus 1 includes a training section 11, a parameter information transmitting section 12, a parameter information obtaining section 13, and an updating section 14. The training section 11 trains a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list.

The parameter information transmitting section 12 transmits, to a server apparatus, first parameter information which indicates at least a part of the first prediction model. The parameter information obtaining section 13 obtains, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values. The updating section 14 updates the first prediction model by replacing the first parameter information with the integrated parameter information.

(Implementation Example by Program)

In a case where the federated learning apparatus 1 is configured by a computer, the following program in accordance with the present example embodiment is stored in a memory (recording medium in accordance with the present example embodiment) of the computer. The program causes the computer to function as: the training section 11 which trains a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list; the parameter information transmitting section 12 which transmits, to a server apparatus, first parameter information which indicates at least a part of the first prediction model; the parameter information obtaining section 13 which obtains, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and the updating section 14 which updates the first prediction model by replacing the first parameter information with the integrated parameter information.

(Flow of Federated Learning Method S1)

The federated learning apparatus 1 configured as described above carries out a federated learning method S1 in accordance with the present example embodiment. The federated learning method S1 is described with reference to FIG. 2. FIG. 2 is a flowchart illustrating a flow of the federated learning method S1. As illustrated in FIG. 2, the federated learning method S1 includes steps S11 to S14.

In the step S11, the training section 11 trains a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list.

In the step S12, the parameter information transmitting section 12 transmits, to a server apparatus, first parameter information which indicates at least a part of the first prediction model.

In the step S13, the parameter information obtaining section 13 obtains, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values.

In the step S14, the updating section 14 updates the first prediction model by replacing the first parameter information with the integrated parameter information.

### Effect of the Present Example Embodiment

As described above, the present example embodiment employs a configuration such that: (i) a first prediction model that predicts an evaluation value corresponding to a combination of a user and an evaluation target with respect to which the evaluation value is not obtained is trained with use of a first training data set including (a) evaluation values each of which is given to one of a part or all of evaluation targets in an evaluation target list and each of which indicates evaluation by one of users in a user list and (b) target attribute values each of which is possessed by one of a part or all of the evaluation targets in the evaluation target list and each of which relates to one of target attributes in a target attribute list; (ii) first parameter information which indicates at least a part of the first prediction model is transmitted to a server apparatus; (iii) integrated parameter information is obtained from the server apparatus, the integrated parameter information being obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and (iv) the first prediction model is updated by replacing the first parameter information with the integrated parameter information. By using the first prediction model generated by the above configuration, an effect that it is possible to generate information appropriate for a receiver of the information is brought about.

### Second Example Embodiment

The following description will discuss, in detail, a second example embodiment of the present invention with reference to drawings. The present example embodiment is made the basis of the third and fourth example embodiments described later.

(Configuration of Server Apparatus 2)

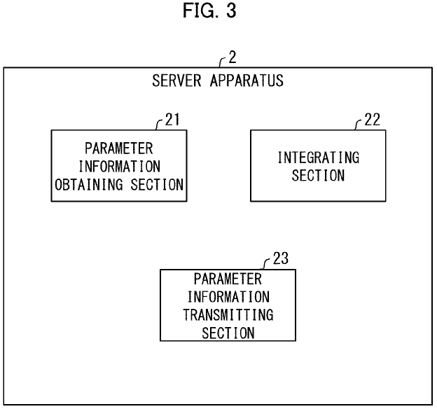

A configuration of a server apparatus 2 in accordance with the present example embodiment is described with reference to FIG. 3. FIG. 3 is a block diagram illustrating the configuration of the server apparatus 2. As illustrated in FIG. 3, the server apparatus 2 includes a parameter information obtaining section 21, an integrating section 22, and a parameter information transmitting section 23. The parameter information obtaining section 21 obtains a plurality of pieces of first parameter information from a respective plurality of federated learning apparatuses 1 each of which functions as the federated learning apparatus 1 in accordance with the first example embodiment. The integrating section 22 generates integrated parameter information by integrating the plurality of pieces of first parameter information. The parameter information transmitting section 23 transmits the integrated parameter information to each of the plurality of federated learning apparatuses 1.

(Implementation Example by Program)

In a case where the server apparatus 2 is configured by a computer, the following program in accordance with the present example embodiment is stored in a memory (recording medium in accordance with the present example embodiment) of the computer. The program causes the computer to function as: the parameter information obtaining section 21 which obtains a plurality of pieces of first parameter information from a respective plurality of federated learning apparatuses 1 each of which functions as the federated learning apparatus 1 in accordance with the first example embodiment; the integrating section 22 which generates integrated parameter information by integrating the plurality of pieces of first parameter information; and the parameter information transmitting section 23 which transmits the integrated parameter information to each of the plurality of federated learning apparatuses 1.

(Flow of federated learning method S2)

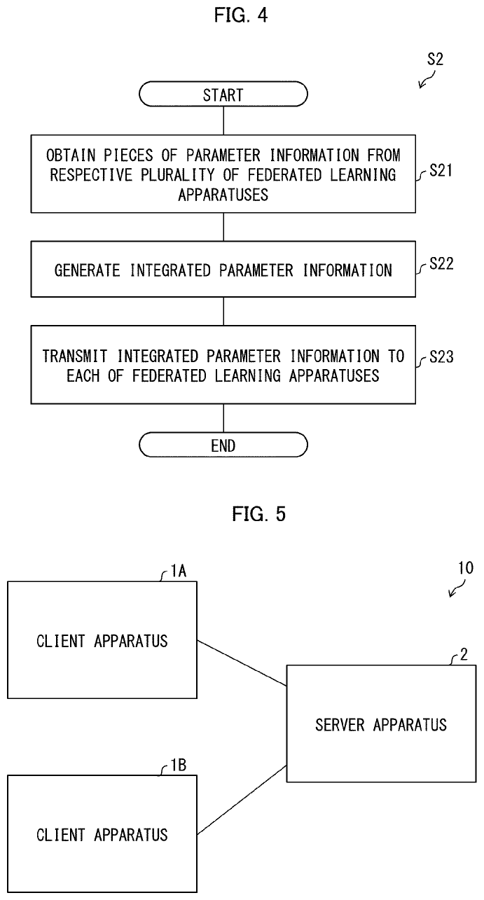

The server apparatus 2 configured as described above carries out a federated learning method S2 in accordance with the present example embodiment. The federated learning method S2 is described with reference to FIG. 4. FIG. 4 is a flowchart illustrating a flow of the federated learning method S2. As illustrated in FIG. 4, the federated learning method S2 includes steps S21 to S23.

In the step S21, the parameter information obtaining section 21 obtains a plurality of pieces of first parameter information from a respective plurality of federated learning apparatuses 1 each of which functions as the federated learning apparatus 1 in accordance with the first example embodiment.

In the step S22, the integrating section 22 generates integrated parameter information by integrating the plurality of pieces of first parameter information.

In the step S23, the parameter information transmitting section 23 transmits the integrated parameter information to each of the plurality of federated learning apparatuses 1.

### Effect of the Present Example Embodiment

As described above, the present example embodiment employs a configuration such that: a plurality of pieces of first parameter information are obtained from a respective plurality of federated learning apparatuses 1 each of which functions as the federated learning apparatus 1 in accordance with the first example embodiment; integrated parameter information is generated by integrating the plurality of pieces of first parameter information; and the integrated parameter information is transmitted to each of the plurality of federated learning apparatuses 1. With the above configuration, by using a first prediction model generated by the federated learning apparatus, an effect that it is possible to generate information appropriate for a receiver of the information is brought about.

### Third Example Embodiment

The following description will discuss, in detail, a third example embodiment of the present invention with reference to drawings. Note that constitutional elements having the same functions as those of the constitutional elements described in the first and second example embodiments are denoted by the same reference signs, and descriptions thereof will not be repeated.

(Configuration of Federated Learning System 10)

A configuration of a federated learning system 10 in accordance with the present example embodiment is described with reference to FIG. 5. FIG. 5 is a block diagram illustrating the configuration of the federated learning system 10. As illustrated in FIG. 5, the federated learning system 10 includes: a plurality of client apparatuses 1A and 1B each of which functions as the federated learning apparatus 1 in accordance with the first example embodiment; and the server apparatus 2 in accordance with the second example embodiment. The server apparatus 2 is communicably connected to each of the client apparatuses 1A and 1B.

(Flow of Federated Learning Method S3)

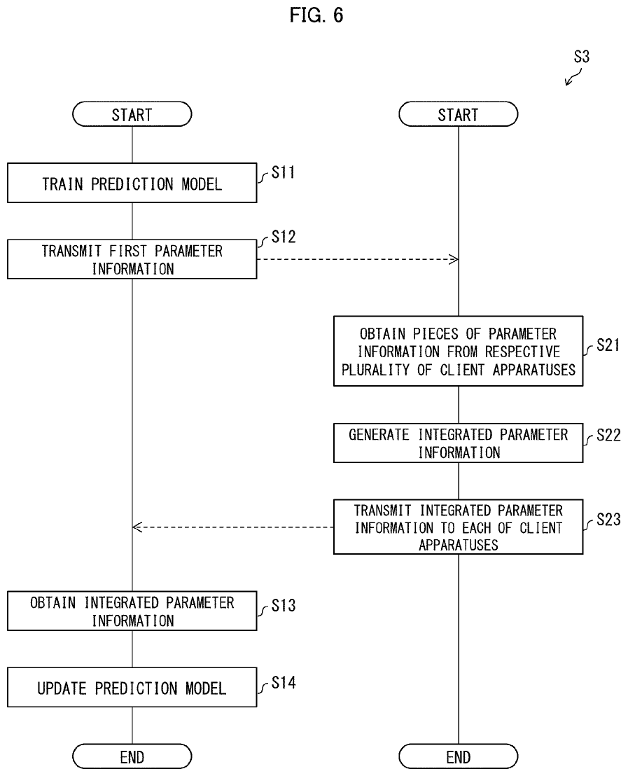

The federated learning system 10 configured as described above carries out a federated learning method S3 in accordance with the present example embodiment. A flow of the federated learning method S3 is described with reference to FIG. 6. FIG. 6 is a flowchart illustrating the flow of the federated learning method S3. As illustrated in FIG. 6, the federated learning method S3 includes steps S11 to S14 and steps S21 to S23.

In the step S11, a training section 11 of the client apparatus 1A trains a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list.

Further, a training section 11 of the client apparatus 1B trains a second prediction model that predicts an evaluation value corresponding to a combination of a user and an evaluation target with respect to which the evaluation value is not obtained, with use of a second training data set which is configured similarly to the first training data set and which differs from the first training data set in at least a part of the evaluation target list, the user list, the target attribute list, the evaluation values, and the target attribute values.

In the step S12, a parameter information transmitting section 12 of the client apparatus 1A transmits, to the server apparatus 2, first parameter information which indicates at least a part of the first prediction model. Further, a parameter information transmitting section 12 of the client apparatus 1B transmits, to the server apparatus 2, first parameter information which indicates at least a part of the second prediction model. Note that the “first parameter information which indicates at least a part of the second prediction model” is an example of second parameter information recited in the claims.

In the step S21, the parameter information obtaining section 21 of the server apparatus 2 obtains a plurality of pieces of first parameter information from the respective plurality of client apparatuses 1A and 1B.

In the step S22, the integrating section 22 of the server apparatus 2 generates integrated parameter information by integrating the plurality of pieces of first parameter information.

In the step S23, the parameter information transmitting section 23 of the server apparatus 2 transmits the integrated parameter information to each of the plurality of client apparatuses 1A and 1B.

In the step S13, a parameter information obtaining section 13 of the client apparatus 1A obtains the integrated parameter information from the server apparatus 2. A parameter information obtaining section 13 of the client apparatus 1B obtains the integrated parameter information from the server apparatus 2.

In the step S14, an updating section 14 of the client apparatus 1A updates the first prediction model by replacing the first parameter information with the integrated parameter information. An updating section 14 of the client apparatus 1B updates the second prediction model by replacing the first parameter information with the integrated parameter information.

### Effect of the Present Example Embodiment

As described above, the present example embodiment employs a configuration such that the federated learning system 10 includes: a plurality of client apparatuses each of which functions as the federated learning apparatus 1 in accordance with the first example embodiment; and the server apparatus 2 in accordance with the second example embodiment. By using a first prediction model generated by the above configuration, an effect that it is possible to generate information appropriate for a receiver of the information is brought about.

### Fourth Example Embodiment

The following description will discuss, in detail, a fourth example embodiment of the present invention with reference to drawings. Note that constitutional elements having the same functions as those of the constitutional elements described in the first to third example embodiments are denoted by the same reference signs, and descriptions thereof will not be repeated. In the present example embodiment, commodities are applied as evaluation targets. As users, users who use a service of selling the commodities are applied.

(Configuration of Federated Learning System 10A)

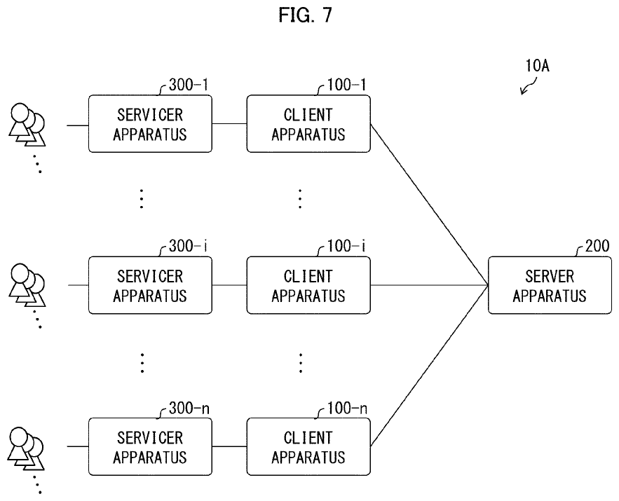

A configuration of a federated learning system 10A in accordance with the present example embodiment is described with reference to FIG. 7. FIG. 7 is a block diagram illustrating the configuration of the entire federated learning system 10A. As illustrated in FIG. 7, the federated learning system 10A includes n client apparatuses 100-i (i=1, 2, . . . n, n is a natural number of 2 or more), a server apparatus 200, and n servicer apparatuses 300-i. The server apparatus 200 is communicably connected to each of the client apparatuses 100-i. Each of the client apparatuses 100-i is communicably connected to a corresponding one of the servicer apparatuses 300-i.

A servicer apparatus 300-i is an apparatus which provides, to one or more users, a service of selling commodities. A user who uses this sale service can give an evaluation value to a commodity sold in the sale service provided by the servicer apparatus 300-i. Hereinafter, the user who uses the sale service provided by the servicer apparatus 300-i is also referred to as simply “user who uses the servicer apparatus 300-i”. Note that FIG. 7 illustrates an example in which a plurality of users use the servicer apparatus 300-i, but the present example embodiment is not limited to this example, and a single user may use the servicer apparatus 300-i. Note also that the same user may use the plurality of servicer apparatuses 300-i.

The server apparatus 200 and each of the client apparatuses 100-i have a predicting function of predicting an evaluation value which would be given to a commodity by a user who uses a corresponding one of the servicer apparatuses 300-i. Each of the servicer apparatuses 300-i, for example, determines a commodity which is to be recommended to the user, on the basis of the evaluation value predicted with use of the predicting function. Each of the servicer apparatuses 300-i can, for example, deliver, to the user, an advertisement of the commodity which is determined to be recommended. In order to realize the predicting function in each of the servicer apparatuses 300-i, the server apparatus 200 and a corresponding one of the client apparatuses 100-i generate a prediction model MLi by federated learning.

Note that a client apparatus 100-i is an example aspect of a federated learning apparatus recited in the claims. The servicer apparatus 300-i includes a part of an example aspect of the federated learning apparatus. The client apparatus 100-i and the servicer apparatus 300-i may be constituted by respective computers which physically differ from each other, or may be alternatively constituted by the same computer.

(Outline of Federated Learning)

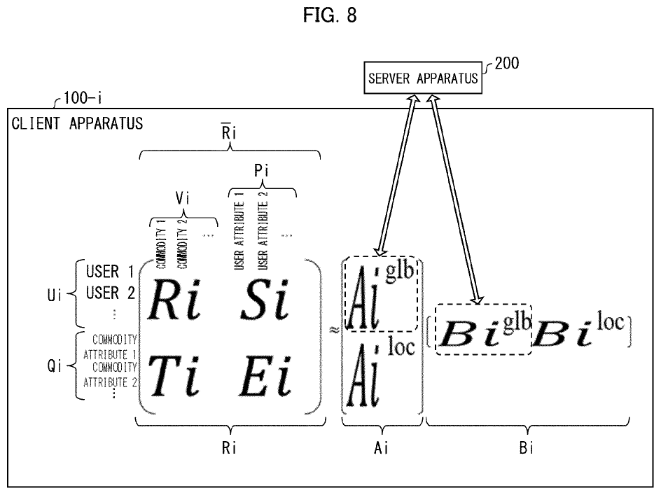

An outline of the federated learning carried out by the federated learning system 10A is described with reference to FIG. 8. FIG. 8 is a schematic view illustrating the outline of the federated learning. Note that a symbol having “-” on the top of a “character string” in each drawing and each formulae referred to in this specification may be referred to as “character string\hat{ }bar” in this specification by adding “\hat{ }bar” to the end of the character string. For example, the following symbols in FIG. 8, formula (3) (described later), etc. may be respectively referred to as “Ri\hat{ }bar” and “Ui\hat{ }bar” in this specification.

$$\begin{matrix}\\ \\ {\overline{R}}_{i} \\ {\overline{U}}_{i}\end{matrix}$$

The same applies to these character strings in the other drawings and the other formulae and to the other character strings.

In addition a symbol having a “superscript” on the right above a “character string” in each drawing and each formulae referred to in this specification may be hereinafter referred to as “character string\hat{ }superscript” by adding “\hat{ }superscript” to the end of the character string. For example, the following symbols in FIG. 8 etc. may be hereinafter respectively referred to as “Ai\hat{ }glb” and “Ai\hat{ }loc”.

$$\begin{matrix}\\ \\ {A}_{i}^{glb} \\ {A}_{i}^{loc}\end{matrix}$$

The same applies to these character strings in the other drawings and the other formulae and to the other character strings.

Further, by combining these, the following symbol in formula (8) etc. may be referred to as “Ui\hat{ }bar\hat{ }loc”.

Ūᵢ^{loc}

The same applies to this character string in the other drawings and the other formulae and to the other character strings.

Ri\hat{ }bar illustrated in FIG. 8 is a two-dimensional matrix, and the matrix Ri\hat{ }bar is an example of a “multidimensional array” recited in the claims. The matrix Ri\hat{ }bar contains, as components, evaluation values given to commodities by users. A component corresponding to a combination of a user and a commodity which is not given an evaluation value is a missing value. Details of the matrix Ri\hat{ }bar are described later. The matrix Ri\hat{ }bar is decomposed into a plurality of vectors Ai and Bi. Ai is a column vector, and Bi is a row vector. Therefore, the number of rows and the number of columns of a product of the vectors Ai and Bi are the same as those of the matrix Ri\hat{ }bar. The matrix Ri\hat{ }bar is generated based on training data set DSi described later. A purpose of learning in the client apparatus 100-i is to determine the vectors Ai and Bi so that a component which is included in the product of the vectors Ai and Bi and which corresponds to an evaluation value that is not missing in the matrix Ri\hat{ }bar approximates more to the evaluation value.

In order to determine such vectors Ai and Bi, the client apparatus 100-i conducts learning so that a difference between (i) the evaluation value that is not missing in the matrix Ri\hat{ }bar and (ii) the corresponding component in the product of the vectors Ai and Bi becomes small. For example, the learning may be conducted by carrying out several steps of a gradient descent method.

Note, here, that, as illustrated in FIG. 8, the vector Ai is composed of a vector Ai\hat{ }glb which can be disclosed and a vector Ai\hat{ }loc which should be concealed. The vector Bi is composed of a vector Bi\hat{ }glb which can be disclosed and a vector Bi\hat{ }loc which should be concealed. The phrase “can be disclosed” refers to being allowed to be disclosed to an apparatus other than the servicer apparatus 300-i and an apparatus other than the client apparatus 100-i. The phrase “should be concealed” refers to being desirably not disclosed to an apparatus other than the servicer apparatus 300-i and an apparatus other than the client apparatus 100-i. Ai\hat{ }glb and Bi\hat{ }glb are examples of first parameter information recited in the claims.

In a case where the client apparatus 100-i determines the vectors Ai and Bi by the learning (step i), the client apparatus 100-i transmits, to the server apparatus 200, the vectors Ai\hat{ }glb and Bi\hat{ }glb each of which is a part of a corresponding one of the determined vectors Ai and Bi (step ii). The server apparatus 200 generates a vector A\hat{ }glb by integrating vectors Ai\hat{ }glb received from the respective plurality of client apparatuses 100-i, and generates a vector B\hat{ }glb by integrating vectors Bi\hat{ }glb received from the respective plurality of client apparatuses 100-i (step iii). The server apparatus 200 then transmits the vectors A\hat{ }glb and B\hat{ }glb to each of the client apparatuses 100-i (step iv). Note, here, that the vectors A\hat{ }glb and B\hat{ }glb are examples of integrated parameter information recited in the claims. The client apparatus 100-i replaces the vector Ai\hat{ }glb in the vector Ai with the vector A\hat{ }glb received from the server apparatus 200, and replaces the vector Bi\hat{ }glb in the vector Bi with the vector B\hat{ }glb received from the server apparatus 200 (step v). The federated learning system 10A completes the learning by repeating such steps i to v until an end condition is satisfied. The vectors Ai and Bi after the learning is completed function as the prediction model MLi.

(Details of Matrix Ri\hat{ }bar)

As illustrated in FIG. 8, the matrix Ri\hat{ }bar contains rows which correspond to respective elements of a user list Ui and rows which correspond to respective elements of a commodity attribute list Qi. The matrix Ri\hat{ }bar also contains columns which correspond to respective elements of a commodity list Vi and columns which correspond to respective elements of a user attribute list Pi. The matrix Ri\hat{ }bar is composed of an evaluation value matrix Ri, a user attribute value matrix Si, a commodity attribute value matrix Ti, and a relevance value matrix Ei.

The evaluation value matrix Ri contains the rows which correspond to the respective elements of the user list Ui and the columns which correspond to the respective elements of the commodity list Vi. The user attribute value matrix Si contains the rows which correspond to the respective elements of the user list Ui and the columns which correspond to the respective elements of the user attribute list Pi. The commodity attribute value matrix Ti contains the rows which correspond to the respective elements of the commodity attribute list Qi and the columns which correspond to the respective elements of the commodity list Vi. The relevance value matrix Ei contains the rows which correspond to the respective elements of the commodity attribute list Qi and the columns which correspond to the respective elements of the user attribute list Pi.

(User List Ui)

The user list Ui shows a list of users who use the servicer apparatus 300-i, and contains user IDs which are for identifying the respective users. In an initial state, the user list Ui may be an empty set or may alternatively contain one or more user IDs in advance. In a case where a user who uses the sale service is newly registered, a user ID which is for identifying the user is added to the user list Ui. For example, in a case where registration for membership is essential in the sale service provided by the servicer apparatus 300-i, the user ID may be an ID given in response to the registration. In the case where the registration for membership is not essential in the sale service, the user ID may be information which makes it possible to uniquely identify the user (e.g. mail address, phone number, etc.), among information inputted at the time of purchase of a commodity.

(Common user list Ui\hat{ }glb)

Note, here, that the user list Ui and at least any one of the other user lists Uj contain a mutually common user. A common user list Ui\hat{ }glb contains a common user ID which is for identifying the user common to the user list Ui and the at least any one of the other user lists Uj. In an initial state, the common user list Ui\hat{ }glb may be an empty set or may alternatively contain one or more common user IDs in advance. A common user ID which is for identifying a user who has been newly found to be common to the user list Ui and any of the other user lists Uj may be added to the common user list Ui\hat{ }glb. The common user ID is also contained in the user list Ui. In other words, the user list Ui contains a user ID which is contained in the common user list Ui\hat{ }glb and a user ID which is not contained in the common user list Ui\hat{ }glb. Note that the user list Ui and each of the other user lists Uj may not contain a mutually common user. In that case, the common user list Ui\hat{ }glb is an empty set.

(Commodity List Vi)

The commodity list Vi shows a list of the commodities sold in the sale service provided by the servicer apparatus 300-i, and contains commodity IDs which are for identifying the respective commodities. The commodity list Vi is an example aspect of an evaluation target list. In an initial state, the commodity list Vi may be an empty set or may alternatively contain one or more commodity IDs in advance. In a case where a commodity to be sold in the sale service is newly registered, a commodity ID which is for identifying the commodity is added to the commodity list Vi. For example, the commodity ID may be an ID which is uniquely given to the commodity in the sale service provided by the servicer apparatus 300-i or may be a one-dimensional code or a two-dimensional code printed on or attached to the commodity, for example, at the time of manufacture of the commodity.

(Common Commodity List Vi\hat{ }glb)

Note, here, that the commodity list Vi and at least any one of the other commodity lists Vj contain a mutually common commodity. A common commodity list Vi\hat{ }glb contains a common commodity ID which is for identifying the commodity common to two or more of the commodity lists V1 to Vn. The common commodity list Vi\hat{ }glb is synchronized between the n servicer apparatuses 300-i. In an initial state, the common commodity list Vi\hat{ }glb may be an empty set or may alternatively contain one or more commodity IDs in advance. A common commodity ID which is for identifying a commodity that has been newly found to be common may be added to the common commodity list Vi\hat{ }glb. The common commodity ID is also contained in the commodity list Vi. In other words, the commodity list Vi contains a commodity ID which is contained in the common commodity list Vi\hat{ }glb and a commodity ID which is not included in the common commodity list Vi\hat{ }glb. Note that the commodity list Vi and each of the other commodity lists Vj may not contain a mutually common commodity. In this case, the common commodity list Vi\hat{ }glb is an empty set.

(User Attribute List Pi)

A user attribute list Pi shows user attributes managed in the sale service provided by the servicer apparatus 300-i, and contains user attribute IDs which are for identifying the respective user attributes. In an initial state, the user attribute list Pi may be an empty set or may alternatively contain one or more user attribute IDs in advance. In a case where a user attribute to be newly managed in the sale service is registered, a user attribute ID which is for identifying the user attribute is added to the user attribute list Pi.

Note, here, that each of the user attributes is information which is defined as an item of information that can be associated with each of the users (user attribute values). It is desirable that each of the user attributes be information which enables classification of the users in accordance with the user attribute values of the each of the user attributes. Each of the user attributes may be, for example, information which is defined as an item that indicates characteristics of the users. Note that, in the present example embodiment, each of the user attribute values is represented by a numerical value. Examples of the user attributes include “gender”, “age”, “address”, “height”, “presence or absence of eyeglasses”, and “family structure”. Examples of the user attribute values which can be set on the user attribute “gender” include numerical values that represent male, female, . . . , and the like (e.g. 1 for male, 2 for female, . . . etc.). Examples of the user attribute values which can be set on the user attribute “age” include: numerical values that represent ages; and numerical values that represent periods of ages such as ages of below 20 years, 20 years to below 40 years, 40 years to below 60 years, and 60 years or older. Examples of the user attribute values which can be set on the user attribute “address” include numerical values that represent prefectures. Examples of the user attribute values which can be set on the user attribute “height” include: numerical values that represent heights; and numerical values that represent heights of shorter than 150 centimeters, 150 centimeters to 170 centimeters, 170 centimeters or taller, and the like. Examples of the user attribute values which can be set on the user attribute “presence or absence of eyeglasses” include numerical values that represent the presence and absence of eyeglasses (e.g. 1 and 0). Examples of the user attribute values which can be set on the user attribute “family structure” include numerical values that represent “single”, “spouse only”, “living together with a parent(s)”, “having a child(children)”, and the like. Note, however, that the examples of the user attributes and the examples of the user attribute values are not limited to the above-described examples.

(Common User Attribute List Pi\hat{ }glb)

Note, here, that the user attribute list Pi and at least any one of the other user attribute lists Pj contain a mutually common user attribute. A common user attribute list Pi\hat{ }glb contains a common user attribute ID which is for identifying the user attribute common to two or more of the user attribute lists P1 to Pn. The common user attribute list Pi\hat{ }glb is synchronized between the n servicer apparatuses 300-i. In an initial state, the common user attribute list Pi\hat{ }glb may be an empty set or may alternatively contain one or more user attribute IDs in advance. A common user attribute ID which is for identifying a user attribute that has been newly found to be common may be added to the common user attribute list Pi\hat{ }glb. The common user attribute ID is also contained in the user attribute list Pi. In other words, the user attribute list Pi contains a user attribute ID which is contained in the common user attribute list Pi\hat{ }glb and a user attribute ID which is not contained in the common user attribute list Pi\hat{ }glb. Note that the user attribute list Pi and each of the other user attribute lists Pj may not contain a mutually common user attribute. In that case, the common user attribute list Pi\hat{ }glb is an empty set.

(Commodity Attribute List Qi)

The commodity attribute list Qi shows commodity attributes managed in the sale service provided by the servicer apparatus 300-i, and contains commodity attribute IDs which are for identifying the respective commodity attributes. The commodity attribute list Qi is an example aspect of a target attribute list. In an initial state, the commodity attribute list Qi of the commodities may be an empty set or may alternatively contain one or more commodity attribute IDs in advance. In a case where a commodity attribute to be newly managed in the sale service is registered, a commodity attribute ID of the commodity attribute is added to the commodity attribute list Qi. Examples of the commodity attribute include food categories and cooking temperature categories.

Note, here, that each of the commodity attributes is information which is defined as an item of information that can be associated with each of the commodities (commodity attribute values). It is desirable that each of the commodity attributes be information which enables classification of the commodities in accordance with the commodity attribute values of the each of the commodity attributes. Each of the commodity attributes may be, for example, information which is defined as an item that indicates characteristics of the commodities. Note that, in the present example embodiment, each of the commodity attribute values is represented by a numerical value. In a case where the commodities are foods, detailed examples of the commodity attributes include “food classification”, “content”, “target customer”, “cooking temperature”, and “storage method”. Examples of the commodity attribute values which can be set on the commodity attribute “food classification” include numerical values that represent meats, vegetables, fruits, breads, . . . , and the like (e.g. 1 for meats, 2 for vegetables, etc.). Examples of the commodity attribute values which can be set on the commodity attribute “content” include numerical values that represent contents (100 grams, etc.). Examples of the commodity attribute values which can be set on the commodity attribute “target customer” include numerical values that represent “for women”, “for children”, “for singles”, . . . , and the like. Examples of the commodity attribute values which can be set on the commodity attribute “cooking temperature” include numerical values that represent a low temperature, a medium temperature, a high temperature, . . . , and the like. Examples of the commodity attribute values which can be set on the commodity attribute “storage method” include numerical values that represent “no refrigeration required”, “keep refrigerated”, “keep frozen”, . . . , and the like. The commodity attributes may be layered. Examples of the layered commodity attributes include “food large classification” and “food small classification”. For example, in a case where a commodity attribute value of the commodity attribute “food large classification” indicates “meats”, examples of the commodity attribute values of the commodity attribute “food small classification” include numerical values that represent processed meats, raw meats, cooked meats, . . . , and the like. Note, however, that the detailed examples of the commodity attributes and the commodity attribute values are not limited to the above-described examples.

(Common Commodity Attribute List Qi\hat{ }glb)

Note, here, that the commodity attribute list Qi and at least any one of the other commodity attribute lists Qj contain a mutually common commodity attribute. A common commodity attribute list Qi\hat{ }glb contains a common commodity attribute ID which is for identifying the commodity attribute common to two or more of the commodity attribute lists Q1 to Qn. The common commodity attribute list Qi\hat{ }glb is synchronized between the n servicer apparatuses 300-i. In an initial state, the common commodity attribute list Qi\hat{ }glb may be an empty set or may alternatively contain one or more common commodity attribute IDs in advance. A common commodity attribute ID which is for identifying a commodity attribute that has been newly found to be common may be added to the common commodity attribute list Qi\hat{ }glb. The common commodity attribute ID is also contained in the commodity attribute list Qi. In other words, the commodity attribute list Qi contains a commodity attribute ID which is contained in the common commodity attribute list Qi\hat{ }glb and a commodity attribute ID which is not included in the common commodity attribute list Qi\hat{ }glb. Note that the commodity attribute list Qi and each of the other commodity attribute lists Qj may not contain a mutually common commodity attribute. In this case, the common commodity attribute list Qi\hat{ }glb is an empty set.

(Evaluation Value Matrix Ri)

The evaluation value matrix Ri indicates the evaluation values each of which is given to one of a part or all of the commodities in the commodity list Vi and each of which is given by one of the users in the user list Ui. For example, each of the evaluation value is information inputted by one of the users. Each of the evaluation values may be one of a plurality of levels of scores (e.g. three levels of scores 1, 2, and 3) or may be alternatively any numerical value included in a given range (e.g. any numerical value of 0 or more and 1 or less). Note, however, that the evaluation values are not limited to these detailed examples. The evaluation value matrix Ri is a matrix containing, as components, evaluation values each of which corresponds to a combination of one of the users and one of the commodities. The evaluation value matrix Ri is contained in the matrix Ri\hat{ }bar in which a part of the evaluation values each of which corresponds to a combination of one of the users and one of the commodities is missing. That is, in the evaluation value matrix Ri, a component which corresponds to a combination of a user and a commodity which is not given an evaluation value is missing. In the evaluation value matrix Ri, all components may be missing in an initial state. In a case where an evaluation value is given to a commodity by a user, the evaluation value is set on a component corresponding to a combination of the commodity and the user. That is, the component on which the evaluation value is set is not missing.

(User Attribute Value Matrix Si)

The user attribute value matrix Si indicates the user attribute values each of which is possessed by one of a part or all of the users in the user list Ui and each of which relates to one of the user attributes in the user attribute list Pi. In other words, the user attribute value matrix Si is a matrix containing, as components, user attribute values each of which corresponds to a combination of one of the user attributes and one of the users. Examples of the user attribute values are as described above. The user attribute value matrix Si is contained in the matrix Ri\hat{ }bar in which a part of the user attribute values each of which corresponds to a combination of one of the user attributes and one of the users is missing. That is, in the user attribute value matrix Si, a component which corresponds to a combination of a user and a user attribute on which a user attribute value is not set is missing. In the user attribute value matrix Si, all components may be missing in an initial state. In a case where a user attribute value of a user attribute is obtained with regard to a user, the user attribute value is set on a component corresponding to a combination of the user attribute and the user.

(Commodity Attribute Value Matrix Ti)

The commodity attribute value matrix Ti indicates the commodity attribute values each of which is possessed by one of a part or all of the commodities in the commodity list Vi and each of which relates to one of the commodity attributes in the commodity attribute list Qi. In other words, the commodity attribute value matrix Ti is a matrix containing, as components, commodity attribute values each of which corresponds to a combination of one of the commodity attributes and one of the commodities. Examples of the commodity attribute values are as described above. The commodity attribute value matrix Ti is contained in the matrix Ri\hat{ }bar in which a part of the commodity attribute values each of which corresponds to a combination of one of the commodity attributes and one of the commodities is missing. That is, in the commodity attribute value matrix Ti, a component which corresponds to a combination of a commodity and a commodity attribute on which a commodity attribute value is not set is missing. In the commodity attribute value matrix Ti, all components may be missing in an initial state. In a case where a commodity attribute value of a commodity attribute is obtained with regard to a commodity, the commodity attribute value is set on a component corresponding to a combination of the commodity attribute and the commodity.

(Relevance Value Matrix Ei)

The relevance value matrix Ei indicates relevance values each of which corresponds to a combination of one of the commodity attributes in the commodity attribute list Qi and one of the user attributes in the user attribute list Pi and each of which indicates relevance of the combination. In other words, the relevance value matrix Ei is a matrix containing, as components, the relevance values each of which corresponds to a combination of one of the commodity attributes and one of the user attributes. Each of the relevance values can be said to indicate an evaluation value which a user having a certain user attribute tends to give to a commodity having a certain commodity attribute. The relevance value matrix Ei can be calculated from the evaluation value matrix Ri, the user attribute value matrix Si, and the commodity attribute value matrix Ti. A method of calculating the relevance value matrix Ei is described later. The relevance value matrix Ei is contained in the matrix Ri\hat{ }bar in which a part of the relevance values each of which corresponds to a combination of one of the commodity attributes contained in the commodity attribute list Qi and one of the user attributes contained in the user attribute list Pi is missing. That is, in the relevance value matrix Ei, a component on which a relevance value is not set is missing depending on missing in the evaluation value matrix Ri, the user attribute value matrix Si, and the commodity attribute value matrix Ti.

(Functional Configuration of Client Apparatus 100-i)

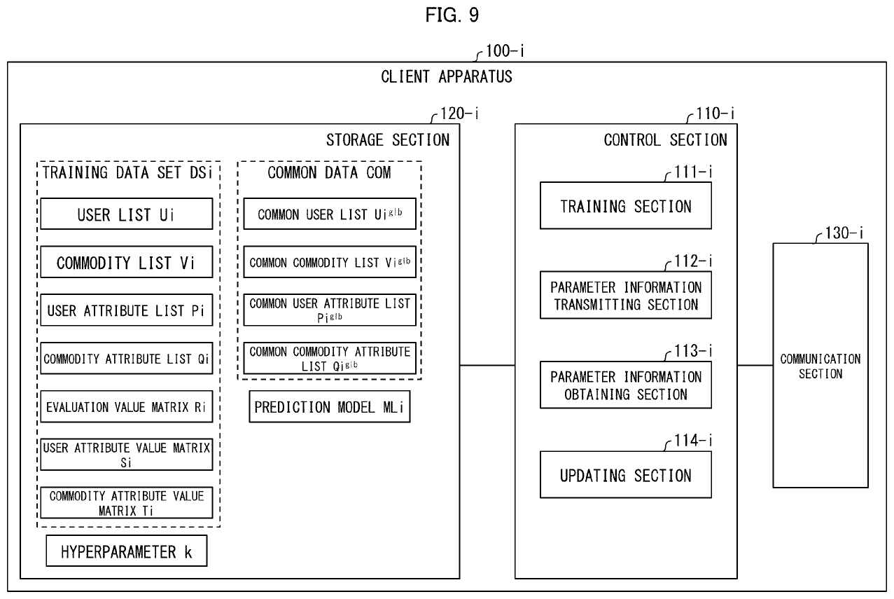

A functional configuration of the client apparatus 100-i is described with reference to FIG. 9. FIG. 9 is a block diagram illustrating the functional configuration of the client apparatus 100-i. As illustrated in FIG. 9, the client apparatus 100-i includes a control section 110-i, a storage section 120-i, and a communication section 130-i. The control section 110-i integrally controls each section of the client apparatus 100-i. The storage section 120-i stores therein various pieces of data used by the control section 110-i. The communication section 130-i carries out communication with another apparatus under control by the control section 110-i.

(Information Stored in Storage Section 120-i)

The storage section 120-i stores therein the training data set DSi, common data COM, a hyperparameter k, and the prediction model MLi. The training data set DSi includes the user list Ui, the commodity list Vi, the user attribute list Pi, and the commodity attribute list Qi. The training data set DSi further includes the evaluation value matrix Ri, the user attribute value matrix Si, the commodity attribute value matrix Ti, and the prediction model MLi. In a case where the training data set DSi is assumed to be an example aspect of a first training data set, a training data set DSj in another client apparatus 100-j is an example aspect of a second training data set. The common data COM includes the common user list Ui\hat{ }glb, the common commodity list Vi\hat{ }glb, the common user attribute list Pi\hat{ }glb, and the common commodity attribute list Qi\hat{ }glb. Details of each information included in the training data set DSi and the common data COM are as described above.

The prediction model MLi is generated by a training section 111-i. The prediction model MLi predicts an evaluation value which corresponds to a combination of a user and a commodity which is not given the evaluation value. In a case where the prediction model MLi is assumed to be an example aspect of a first prediction model, a prediction model MLj in another client apparatus 100-j is an example aspect of a second prediction model.

The hyperparameter k is used by the training section 111-i so as to train the prediction model MLi. The hyperparameter k is a predetermined natural number, and the same value is used between the server apparatus 200 and the n client apparatuses 100-i.

(Details of control section 110-i)

The control section 110-i includes the training section 111-i, a parameter information transmitting section 112-i, a parameter information obtaining section 113-i, and an updating section 114-i. The training section 111-i trains the prediction model MLi with use of the training data set DSi. More specifically, the training section 111-i expresses the training data set DSi as the matrix Ri\hat{ }bar, and determines, as the prediction model MLi, the plurality of vectors Ai and Bi which are obtained by decomposing the matrix Ri\hat{ }bar. Details of a client learning process are described later.

More specifically, for example, the training section 111-i determines the plurality of vectors Ai and Bi so that a component which is included in the product of the plurality of vectors Ai and Bi and which corresponds to an evaluation value that is not missing in the evaluation value matrix Ri approximates to the evaluation value. Further, the training section 111-i determines the plurality of vectors Ai and Bi so that a component which is included in the product of the plurality of vectors Ai and Bi and which corresponds to a user attribute value that is not missing in the user attribute value matrix Si approximates to the user attribute value. Further, the training section 111-i determines the plurality of vectors Ai and Bi so that a component which is included in the product of the plurality of vectors Ai and Bi and which corresponds to a commodity attribute value that is not missing in the commodity attribute value matrix Ti approximates to the commodity attribute value.

Further, the training section 111-i determines the plurality of vectors Ai and Bi so that a component which is included in the product of the plurality of vectors Ai and Bi and which corresponds to a relevance value that is not missing in the relevance value matrix Ei approximates to the relevance value. Note that the training section 111-i calculates each of the relevance values which compose the relevance value matrix Ei, on the basis of a value obtained by dividing a product of one of the user attribute values and one of the commodity attribute values by an evaluation value which corresponds to the one of the user attribute values and the one of the commodity attribute values.

The parameter information transmitting section 112-i transmits, to the server apparatus 200, at least a part of the vector Ai as the first parameter information Ai\hat{ }glb, and transmits, to the server apparatus 200, at least a part of the vector Bi as the first parameter information Bi\hat{ }glb. The first parameter information Ai\hat{ }glb and Bi\hat{ }glb are parameter information disclosed to the server apparatus 200. More specifically, the parameter information transmitting section 112-i transmits, as the first parameter information Ai\hat{ }glb and Bi\hat{ }glb, parameter information obtained based on, among the plurality of vectors Ai and Bi, information common to the training data set DSi and at least any one of the other training data sets DSj (common data COM). Note that the common information includes information indicating a common commodity, a common user, a common commodity attribute, or a common user attribute.

The parameter information obtaining section 113-i obtains the integrated parameter information A\hat{ }glb and B\hat{ }glb from the server apparatus 200. The updating section 114-i updates the prediction model MLi by replacing the first parameter information Ai\hat{ }glb and Bi\hat{ }glb in the respective plurality of vectors Ai and Bi with the integrated parameter information A\hat{ }glb and B\hat{ }glb, respectively.

(Functional Configuration of Server Apparatus 200)

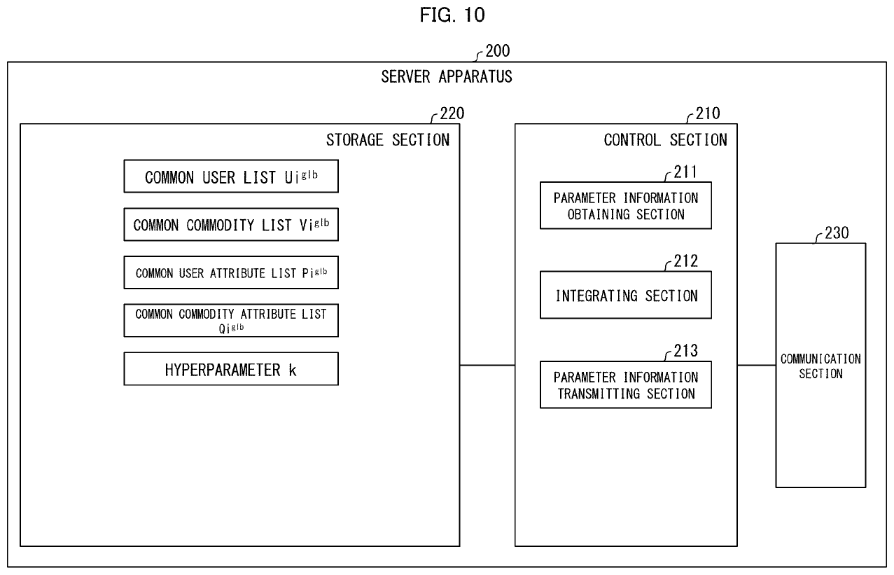

A functional configuration of the server apparatus 200 is described with reference to FIG. 10. FIG. 10 is a block diagram illustrating the functional configuration of the server apparatus 200. As illustrated in FIG. 10, the server apparatus 200 includes a control section 210, a storage section 220, and a communication section 230. The control section 210 integrally controls each section of the server apparatus 200. The storage section 220 stores therein various pieces of data used by the control section 210. The communication section 230 carries out communication with another apparatus under control by the control section 210.

(Information Stored in Storage Section 220)

The storage section 220 stores therein the common data COM and the hyperparameter k. The common data COM includes common user lists U1\hat{ }glb to Un\hat{ }glb, common commodity lists V1\hat{ }glb to Vn\hat{ }glb, common user attribute lists P1\hat{ }glb to Pn\hat{ }glb, and common commodity attribute lists Q1\hat{ }glb to Qn\hat{ }glb. Details of each of the lists and hyperparameter k are as described in connection with the client apparatus 100-i.

Note that the number of the common user lists Ui\hat{ }glb stored in the storage section 220 is equal to the number (n) of the client apparatuses 100-i. In the storage section 220, a single common commodity list Vi\hat{ }glb, a single common user attribute list Pi\hat{ }glb, and a single common commodity attribute list Qi\hat{ }glb are stored, because these lists are common to the servicer apparatuses 300-i.

(Details of Control Section 210)

The control section 210 includes a parameter information obtaining section 211, an integrating section 212, and a parameter information transmitting section 213. The parameter information obtaining section 211 obtains the first parameter information Ai\hat{ }glb and Bi\hat{ }glb from each of the plurality of client apparatuses 100-i. The integrating section 212 generates the integrated parameter information A\hat{ }glb and B\hat{ }glb by integrating the plurality of pieces of first parameter information. Details of an integrating process are described later. The parameter information transmitting section 213 transmits the integrated parameter information A\hat{ }glb and B\hat{ }glb to each of the plurality of client apparatuses 100-i.

(Functional Configuration of Servicer Apparatus 300-i)

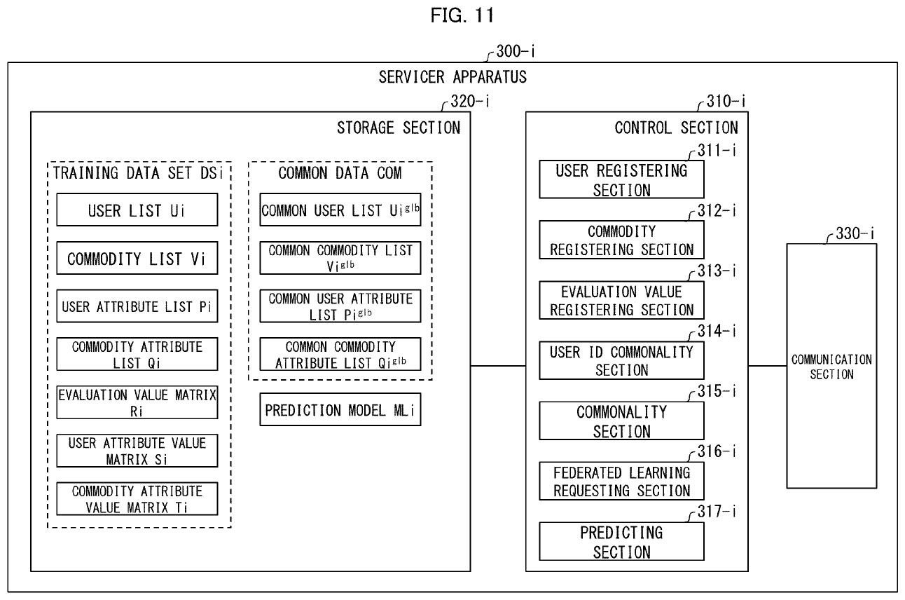

A functional configuration of the servicer apparatus 300-i is described with reference to FIG. 11. FIG. 11 is a block diagram illustrating the functional configuration of the servicer apparatus 300-i. As illustrated in FIG. 11, the servicer apparatus 300-i includes a control section 310-i, a storage section 320-i, and a communication section 330-i. The control section 310-i integrally controls each section of the servicer apparatus 300-i. The storage section 320-i stores therein various pieces of data used by the control section 310-i. The communication section 330-i carries out communication with another apparatus under control by the control section 310-i.

(Information Stored in Storage Section 320-i)

The storage section 320-i stores therein the training data set DSi, the common data COM, the hyperparameter k, and the prediction model MLi. These pieces of information are as described in connection with the storage section 120-i of the client apparatus 100-i. Note that, although details are described later, the training data set DSi stored in the client apparatus 100-i is one that has been transferred from the servicer apparatus 300-i. The prediction model MLi stored in the servicer apparatus 300-i is one that has been transferred from the client apparatus 100-i.

(Details of Control Section 310-i)

The control section 310-i includes a user registering section 311-i, a commodity registering section 312-i, an evaluation value registering section 313-i, a user ID commonality section 314-i, a commonality section 315-i, a federated learning requesting section 316-i, and a predicting section 317-i.

The user registering section 311-i carries out a process of registering a user who uses the sale service provided by the servicer apparatus 300-i, and generates/updates the user list Ui. The commodity registering section 312-i carries out a process of registering a commodity to be sold in the sale service, and generates/updates the commodity list Vi.

The evaluation value registering section 313-i carries out a process of registering an evaluation value given to a commodity by a user, and generates/updates the evaluation value matrix Ri. The user ID commonality section 314-i carries out a process of making a user ID common to the servicer apparatus 300-i and each of the other servicer apparatuses 300-j, and generates/updates the common user list Ui\hat{ }glb. The commonality section 315-i carries out a process of making a commodity, a user attribute, and a commodity attribute common to the servicer apparatus 300-i and each of the other servicer apparatuses 300-j, and generates/updates the common commodity list Vi\hat{ }glb, the common user attribute list Pi\hat{ }glb, and the common commodity attribute list Qi\hat{ }glb.

The federated learning requesting section 316-i obtains the prediction model MLi by requesting a federated learning process to the client apparatus 100-i. The predicting section 317-i predicts, with use of the prediction model MLi, an evaluation value which corresponds to a combination of a user and a commodity which is not given the evaluation value.

(Operation of Federated Learning System 10A)

The federated learning system 10A configured as described above carries out information processing methods S4 to S9 and a federated learning method S10 in accordance with the present example embodiment. The information processing methods S4 to S7 are each a method for obtaining the training data set DSi. The information processing methods S8 and S9 are each a method for generating the common data COM.

(Information Processing Method S4: User Registration)

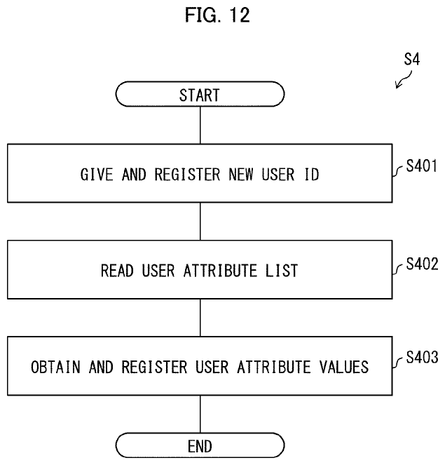

The information processing method S4 shows a user registering process carried out by the servicer apparatus 300-i. The information processing method S4 is carried out when a new user starts to use the sale service provided by the servicer apparatus 300-i. The information processing method S4 is described with reference to FIG. 12. FIG. 12 is a flowchart illustrating a flow of the information processing method S4. As illustrated in FIG. 12, the information processing method S4 includes steps S401 to S403.

In the step S401, the user registering section 311-i gives a new user ID to a new user, and adds the user ID to the user list Ui.

In the step S402, the user registering section 311-i reads all or a part of the user attributes contained in the user attribute list Pi.

In the step S403, the user registering section 311-i obtains the user attribute values of each of the read user attributes. For example, the user registering section 311-i may display, on a user terminal (not illustrated), a user interface on which the user attributes are inputted, and obtain the user attribute values on the basis of information inputted from the user terminal. The user registering section 311-i adds the obtained user attribute values to the user attribute value matrix Si.

Hereinafter, in the user attribute value matrix Si, a user attribute value which is of a user attribute v and which is possessed by a user u is also referred to as Si[u, v]. Note that u is a user ID contained in the user list Ui and the user u refers to a user having a user ID of u. Note also that v is a user attribute ID contained in the user attribute list Pi, and the user attribute v refers to a user attribute having a user attribute ID of v. Note that Si[u, v] may not always be obtained. As a detailed example, there is a case where, for example, the user u has not inputted a response to a question as to the user attribute v. As another detailed example, there is a case where the user u (e.g. 30 years old) originally does not have the user attribute v (annual incomes of 40 year-old users). In this case, Si[u, v] is a missing value. The missing value is hereinafter referred to as “NULL”. Therefore, that Si[u, v] is a missing value is expressed as “Si[u, v]=NULL”. The user attribute value matrix Si is a multidimensional array. The user registering section 311-i need not store, in the storage section 320-i, a component of the missing value in the user attribute value matrix Si. This makes it possible to save a storage area of the storage section 320-i.

The user registering section 311-i may add a new user attribute to the user attribute list Pi after operation of the sale service is started by the servicer apparatus 300-i. For example, in a case where some kind of campaign is carried out in the sale service, the user registering section 311-i may add, to the user attribute list Pi, a user attribute such as “whether or not a user has entered the campaign ∘∘” or “the amount of money used for purchase during the campaign ∘∘”. In this case, the user registering section 311-i asks a user about the added user attribute, and adds, to the user attribute value matrix Si, an inputted response as a user attribute value.

In the present example embodiment, it is assumed that the servicer apparatus 300-i converts each of the user attribute values into a numerical value. However, the present example embodiment is not limited to this example. Each of the user attribute values may be stored as a character string in the servicer apparatus 300-i, and the client apparatus 100-i may convert each of the user attribute values into a numerical value from a character string.

(Information Processing Method S5: Commodity Registration)

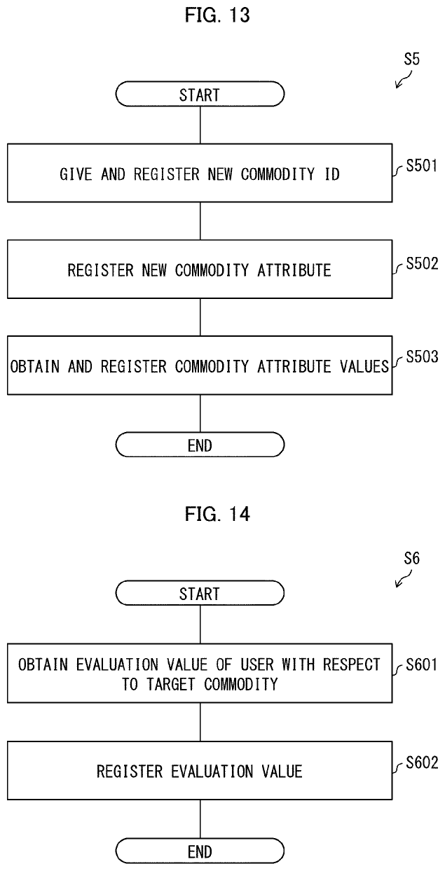

The information processing method S5 shows a commodity registering process carried out by the servicer apparatus 300-i. The information processing method S5 is carried out when a new commodity is received in the sale service provided by the servicer apparatus 300-i. The information processing method S5 is described with reference to FIG. 13. FIG. 13 is a flowchart illustrating a flow of the information processing method S5. As illustrated in FIG. 13, the information processing method S5 includes steps S501 to S503.

In the step S501, the commodity registering section 312-i gives a new commodity ID to a new commodity, and adds the commodity ID to the commodity list Vi. Note that the commodity registering section 312-i may give a commodity ID which is original to the servicer apparatus 300-i, or may use, as a commodity ID, a one-dimensional code or a two-dimensional code which has been attached to (for example, printed or pasted on) a commodity (or its packaging body, or the like) at the time of, for example, manufacture of the commodity.

In the step S502, the commodity registering section 312-i obtains information indicating (i) one or more commodity attributes associated with the new commodity and (ii) commodity attribute values of each of the one or more commodity attributes. In a case where, among the obtained one or more commodity attributes, there is a new commodity attribute which is not contained in the commodity attribute list Qi, the commodity registering section 312-i adds the new commodity attribute to the commodity attribute list Qi.

In the step S503, the commodity registering section 312-i adds, to the commodity attribute value matrix Ti, the commodity attribute values of each of the one or more commodity attributes associated with the new commodity.

Hereinafter, in the commodity attribute value matrix Ti, a commodity attribute value which is of a commodity attribute u and which is possessed by a commodity v is also referred to as Ti[u, v]. Note that u is a commodity attribute ID contained in the commodity attribute list Qi, and the commodity attribute u refers to a commodity attribute having a commodity attribute ID of u. Note also that v is a commodity ID contained in the commodity list Vi, and the commodity v refers to a commodity having a commodity ID of v. Note that Ti[u, v] may not always be obtained. For example, there is a case where the commodity v (e.g., a car) originally does not have the commodity attribute v (whether the commodity is sweet or not when eaten). In this case, Ti[u, v] is a missing value, and is expressed as “Ti[u, v]=NULL”. The commodity attribute value matrix Ti is a multidimensional array. The commodity registering section 312-i need not store, in the storage section 320-i, a component of the missing value in the commodity attribute value matrix Ti. This makes it possible to save the storage area of the storage section 320-i.

The commodity registering section 312-i may add a new commodity attribute to the commodity attribute list Qi after the operation of the sale service is started by the servicer apparatus 300-i. For example, it is assumed that the commodity registering section 312-i has obtained information relating to a new commodity attribute about an existing commodity (e.g., “a commodity which is often sold to women in their thirties”), from a manufacturer of the commodity. In this case, the commodity registering section 312-i may add, to the commodity attribute list Qi, the new commodity attribute “whether or not a commodity is sold well to people in their thirties”, and add, to the commodity attribute value matrix Ti, commodity attribute values (sold well) of the commodity.

(Information Processing Method S6: Evaluation Value Registration)

The information processing method S6 shows an evaluation value registering process carried out by the servicer apparatus 300-i. The information processing method S6 is carried out when a user gives an evaluation value to a commodity in the sale service provided by the servicer apparatus 300-i. In the sale service, a user can, for example, evaluate the quality of a commodity in five levels (give one of five levels of evaluation values). The information processing method S6 is described with reference to FIG. 14. FIG. 14 is a flowchart illustrating a flow of the information processing method S6. As illustrated in FIG. 14, the information processing method S6 includes steps S601 and S602.

In the step S601, the evaluation value registering section 313-i obtains, from the user terminal or the like, an evaluation value of a user with respect to a commodity v. For example, the evaluation value registering section 313-i may obtain an evaluation value inputted by the user u with respect to the commodity v. In the step S602, the evaluation value registering section 313-i registers the obtained evaluation value in the evaluation value matrix Ri.

Hereinafter, in the evaluation value matrix Ri, the evaluation value of the user u with respect to the commodity v is also referred to as Ri[u, v]. The user u and the commodity v are as described above. Note that in a case where the evaluation value with respect to the commodity v is not obtained, Ri[u, v] is a missing value, and is expressed as “Ri[u, v]=NULL”. The evaluation value matrix Ri is a multidimensional array. The evaluation value registering section 313-i need not store, in the storage section 320-i, a component of the missing value in the evaluation value matrix Ri. This makes it possible to save the storage area of the storage section 320-i.

(Information Processing Method S7: User ID Commonality)

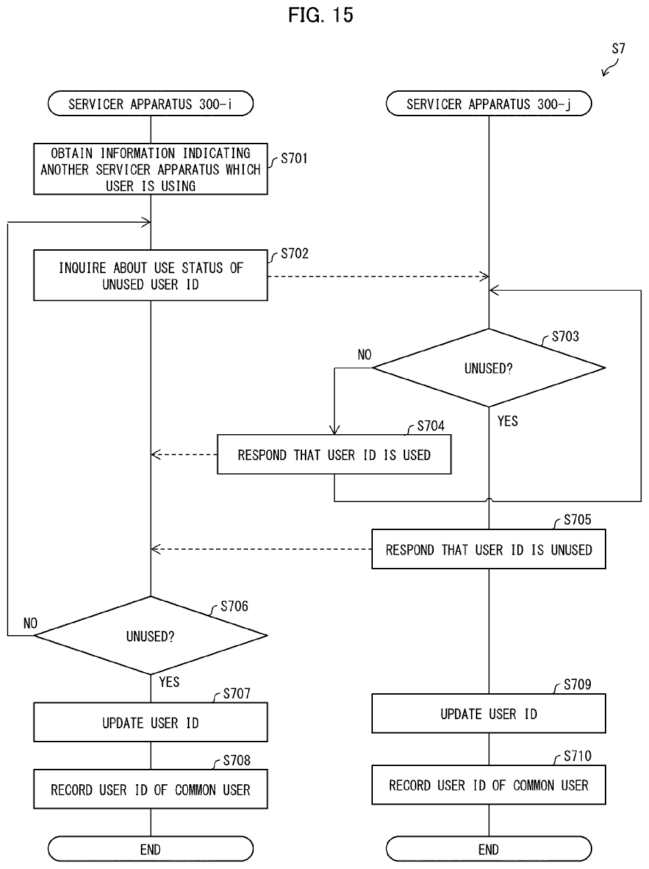

The information processing method S7 shows a user ID commonality process carried out by the servicer apparatus 300-i. For example, the information processing method S7 is carried out when information indicating that a user who uses the servicer apparatus 300-i is using another servicer apparatus 300-j is obtained from the user. For example, the servicer apparatus 300-i may be configured to give, to a user, a reward corresponding to registration of information indicating that the user is using another servicer apparatus 300-j. Detailed examples of the reward include, but are not limited to, paying a remuneration, lowering a service charge, and discounting a price of a commodity. This makes it possible to find a user common to the user list Ui and a user list Uj with higher accuracy. As a result, it is possible to improve the accuracy of the prediction model MLi. The information processing method S7 is described with reference to FIG. 15. FIG. 15 is a flowchart illustrating a flow of the information processing method S7. As illustrated in FIG. 15, the information processing method S7 includes steps S701 to S710.

In the step S701, the user ID commonality section 314-i obtains, from a user u 1, information indicating that the user u1 is using another servicer apparatus 300-j. The obtained information includes a user ID “u2” of the user u 1 in the another servicer apparatus 300-j.

In the step S702, the user ID commonality section 314-i determines an unused user ID “u-com” as a candidate common user ID. The “unused” means not being contained in the user list Ui. The user ID commonality section 314-i transmits, to the servicer apparatus 300-j, the candidate common user ID “u-com” and the user ID “u2” in the servicer apparatus 300-j.

In the step S703, a user ID commonality section 314-j of the servicer apparatus 300-j determines whether or not the candidate common user ID “u-com” is unused. Specifically, in a case where u-com is not contained in the user list Uj, the user ID commonality section 314-j determines that u-com is unused (YES). In a case where u-com is contained in the user list Uj, the user ID commonality section 314-j determines that u-com is not unused (NO).

In a case where a determination of NO is made in the step S703, the step S704 is carried out. In the step S704, the user ID commonality section 314-j transmits a response “used” to the servicer apparatus 300-i. In a case where a determination of YES is made in the step S703, the step S705 is carried out. In the step S705, the user ID commonality section 314-j transmits a response “unused” to the servicer apparatus 300-i.

In the step S706, the user ID commonality section 314-i of the servicer apparatus 300-i determines whether or not the response received from the servicer apparatus 300-j is “unused”. In a case where a determination of NO (used) is made in the step S706, the user ID commonality section 314-i repeats the processes from the step S702. Note that, in the step S702 in the repetition, a new candidate “u-com” which is not contained in the user list Ui and which differs from previous candidates is determined as a candidate common user ID that is unused.

In a case where a determination of YES (unused) is made in the step S706, the step S707 is carried out. In the step S707, the user ID commonality section 314-i updates u1 in the user list Ui to u-com. In the step S708, the user ID commonality section 314-i adds u-com to the common user list Uij\hat{ }glb.

In the servicer apparatus 300-j, in a case where the user ID commonality section 314-j again receives a new candidate common user ID from the servicer apparatus 300-i after having transmitted a response “used” in the step S704, the user ID commonality section 314-j repeats the processes from the step S703.

After having transmitted the response “unused” in the step S705, the user ID commonality section 314-j carries out the steps S709 and S710. In the step S709, the user ID commonality section 314-j updates u2 in the user list Uj to u-com.

In the step S710, the user ID commonality section 314-i adds u-com to the common user list Uij\hat{ }glb. With regard to all j other than i, the user ID commonality section 314-i stores, in the storage section 320-i, a union set of common user lists Uij\hat{ }glb as Ui\hat{ }glb.

(Information Processing Method S8: Commonality)

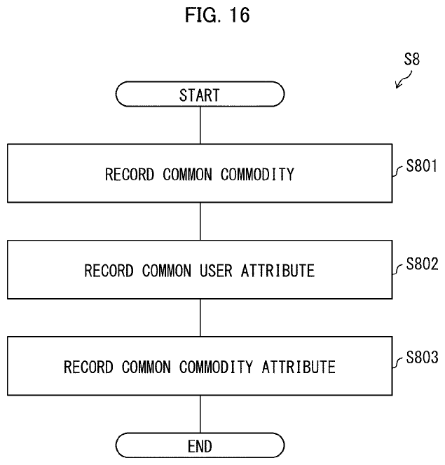

The information processing method S8 shows a commonality process carried out by the servicer apparatus 300-i. The information processing method S8 is carried out at any point in time so that the servicer apparatus 300-i finds a commodity, a user attribute, and a commodity attribute common to the servicer apparatus 300-i and each of the other servicer apparatuses 300-j. For example, the servicer apparatus 300-i may carry out the information processing method S8 at given intervals or may carry out the information processing method S8 in response to an execution instruction given by a manager. The information processing method S8 only needs to be carried out by at least one of the n servicer apparatuses 300-i. The information processing method S8 is described with reference to FIG. 16. FIG. 16 is a flowchart illustrating a flow of the information processing method S8. As illustrated in FIG. 16, the information processing method S8 includes steps S801 to S803.

In the step S801, the commonality section 315-i obtains a commodity list Vj from each of the other servicer apparatuses 300-j, and generates the common commodity list Vi\hat{ }glb on the basis of the n commodity lists V1 to Vn. A detailed example of a process of generating the common commodity list Vi\hat{ }glb is described. For example, first, the commonality section 315-i extracts commodities each of which is common to two or more of the commodity lists V1 to Vn. Note that a given condition for extracting the common commodities may be defined. Examples of the given condition include, but are not limited to, a condition that one or more given commodity attribute values (e.g., commodity name, manufacturer name, etc.) are the same. The commonality section 315-i gives a common commodity ID to each of the extracted commodities. As the common commodity ID, used is an ID which differs from the other common commodity IDs and also differs from a commodity ID of a commodity that is not common to any of the n commodity lists V1 to Vn. The commonality section 315-i then updates the two or more of the commodity lists V1 to Vn by changing, to a corresponding common commodity ID, a commodity ID of each of the commodities each of which is common to the two or more of the commodity lists V1 to Vn. The commonality section 315-i adds, to the common commodity list Vi\hat{ }glb, the common commodity ID of each of the common commodities. The commonality section 315-i transmits, to each of the other servicer apparatuses 300-j, the updated commodity list Vj and the generated common commodity list Vi\hat{ }glb, and causes the commodity list Vj and the common commodity list Vi\hat{ }glb to be stored in the storage section 320-j.

In the step S802, the commonality section 315-i obtains a user attribute list Pj from each of the other servicer apparatuses 300-j, and generates the common user attribute list Pi\hat{ }glb on the basis the n user attribute lists P1 to Pn. A detailed example of a process of generating the common user attribute list Pi\hat{ }glb is described. For example, first, the commonality section 315-i extracts user attributes each of which is common to two or more of the user attribute lists P1 to Pn. Note that a given condition for extracting the common user attributes may be defined. Examples of the given condition include, but are not limited to, a condition that names of user attributes are the same. The commonality section 315-i gives a common user attribute ID to each of the extracted user attributes. As the common user attribute ID, used is an ID which differs from the other common user attribute IDs and also differs from a user attribute ID of a user attribute that is not common to any of the n user attribute lists P1 to Pn. The commonality section 315-i then updates the two or more of the user attribute lists P1 to Pn by changing, to a corresponding common user attribute ID, a user attribute ID of each of the user attributes each of which is common to the two or more of the user attribute lists P1 to Pn. The commonality section 315-i adds, to the common user attribute list Pi\hat{ }glb, the common user attribute ID of each of the common user attributes. The commonality section 315-i transmits, to each of the other servicer apparatuses 300-j, the updated user attribute list Pj and the generated common user attribute list Pi\hat{ }glb, and causes the user attribute list Pj and the common user attribute list Pi\hat{ }glb to be stored in the storage section 320-j.

In the step S803, the commonality section 315-i obtains a commodity attribute list Qj from each of the other servicer apparatuses 300-j, and generates the common commodity attribute list Qi\hat{ }glb on the basis of the n commodity attribute lists Q1 to Qn. A detailed example of a process of generating the common commodity attribute list Qi\hat{ }glb is described. For example, first, the commonality section 315-i extracts commodity attributes each of which is common to two or more of the commodity attribute lists Q1 to Qn. Note that a given condition for extracting the common commodity attributes may be defined. Examples of the given condition include, but are not limited to, a condition that names of commodity attributes are the same. The commonality section 315-i gives a common commodity attribute ID to each of the extracted commodity attributes. As the common commodity attribute ID, an ID is used which differs from the other common commodity attribute IDs and also differs from a commodity attribute ID of a commodity attribute that is not common to any of the n commodity attribute lists Q1 to Qn. The commonality section 315-i then updates the two or more of the commodity attribute lists Q1 to Qn by changing, to a corresponding common commodity attribute ID, a commodity attribute ID of each of the commodity attributes each of which is common to the two or more of the commodity attribute lists Q1 to Qn. The commonality section 315-i adds, to the common commodity attribute list Qi\hat{ }glb, the common commodity attribute ID of each of the common commodity attributes. The commonality section 315-i transmits, to each of the other servicer apparatuses 300-j, the updated commodity attribute list Qj and the generated common commodity attribute list Qi\hat{ }glb, and causes the commodity attribute list Qj and the common commodity attribute list Qi\hat{ }glb to be stored in the storage section 320-j.

Hereinafter, an element in the common commodity list Vi\hat{ }glb is referred to as a common commodity ID. An element in the common user attribute list Pi\hat{ }glb is referred to as a common user attribute. An element in the common commodity attribute list Qi\hat{ }glb is referred to as a common commodity attribute. An element which is contained in Vi but is not contained in Vi\hat{ }glb is referred to as a unique commodity ID. An element which is contained in Pi but is not contained in Pi\hat{ }glb is referred to as a unique user attribute. An element which is contained in Qi but is not contained in Qi\hat{ }glb is referred to as a unique commodity attribute.

Note that in a case where information (such as the above-described one-dimensional code or two-dimensional code) given to a commodity at the time of, for example, manufacture is used as a commodity ID, the commodity can be uniquely identified by the commodity ID throughout all the commodity lists V1, V2, . . . , Vn. Therefore, the process in the step S801 can be simplified as follows. That is, the commonality section 315-i extracts, as a common commodity ID, a commodity ID common to two or more of the commodity lists V1 to Vn. Thus, the commonality section 315-i only needs to carry out the process of adding the common commodity ID to the common commodity list Vi\hat{ }glb, without carrying out the process of issuing a new common commodity ID and updating the two or more of the commodity lists V1 to Vn. Also with regard to the commodity attributes, a case is considered where a predetermined standard commodity attribute ID is used in each of the commodity attribute lists Q1 to Qn. Also with regard to the user attributes, a case is considered where a predetermined standard user attribute ID is used in each of the user attribute lists P1 to Pn. In these cases, the processes in the steps S802 and S803 can be also simplified similarly to the step S801.

The information processing method S8 is based on a premise that each of the other servicer apparatuses 300-j discloses the commodity list Vj, the user attribute list Pj, the commodity attribute list Qj to the single servicer apparatus 300-i. Note, however, that each of the servicer apparatuses 300-j may be configured to (i) conceal information which cannot be disclosed due to, for example, a trade secret and (ii) disclose information, other than the concealed information, in the commodity list Vj, the user attribute list Pj, and the commodity attribute list Qj. In this case, the concealed information is treated as a unique commodity ID, a unique user attribute, or a unique commodity attribute.

Note also that the information processing method S8 may be carried out by the server apparatus 200, instead of being carried out by the single servicer apparatus 300-i. In this case, the servicer apparatus 300-i and the client apparatus 100-i do not need to generate/store the commodity list Vi\hat{ }glb, the user attribute list Pi\hat{ }glb, and the commodity attribute list Qi\hat{ }glb. Therefore, a calculation load is reduced, and the storage area is saved.

(Information Processing Method S9: Federated Learning Request, Federated Learning Acceptance)

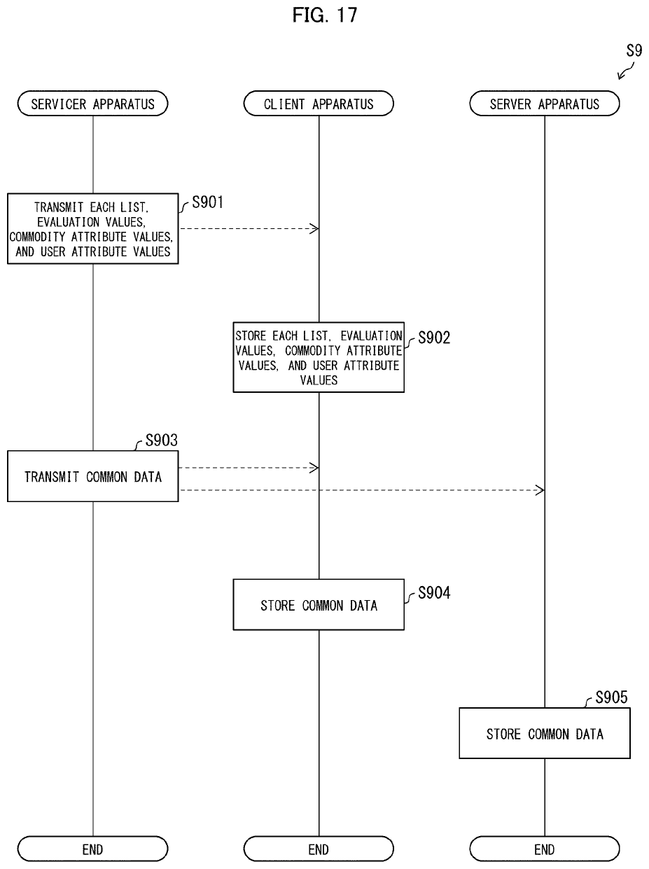

The information processing method S9 shows a federated learning requesting process and a federated learning accepting process carried out by the federated learning system 10A. For example, the information processing method S9 is carried out when the servicer apparatus 300-i completes the information processing methods S4 to S8. The information processing method S9 may be carried out periodically or in response to an instruction given by the manager. The information processing method S9 is described with reference to FIG. 17. FIG. 17 is a flowchart illustrating a flow of the information processing method S9. As illustrated in FIG. 17, the information processing method S9 includes steps S901 to S905.

In the step S901, the federated learning requesting section 316-i transmits, to the client apparatus 100-i, the training data set DSi stored in the storage section 320-i. As described above, the training data set DSi includes the user list Ui, the commodity list Vi, the user attribute list Pi, the commodity attribute list Qi, the evaluation value matrix Ri, the user attribute value matrix Si, and the commodity attribute value matrix Ti. Note, here, that the evaluation value matrix Ri, the user attribute value matrix Si, and the commodity attribute value matrix Ti each include a missing value, as described above. Therefore, the federated learning requesting section 316-i can reduce traffic by not transmitting a part corresponding to the missing value.

In the step S902, the client apparatus 100-i stores the received training data set DSi in the storage section 120-i.

In the step S903, the federated learning requesting section 316-i of the servicer apparatus 300-i transmits, to each of the client apparatus 100-i and the server apparatus 200, the common data COM stored in the storage section 320-i. As described above, the common data COM includes the common user list Ui\hat{ }glb, the common commodity list Vi\hat{ }glb, the common user attribute list Pi\hat{ }glb, and the common commodity attribute list Qi\hat{ }glb.

Note that, with regard to the common commodity list Vi\hat{ }glb, the common user attribute list Pi\hat{ }glb, and the common commodity attribute list Qi\hat{ }glb among the common data COM, the n servicer apparatuses 300-i store the same information. Therefore, at least one of the n servicer apparatuses 300-i may carry out a process of transmitting these lists to the server apparatus 200.

Among the common data COM, the common user list Ui\hat{ }glb is described as being generated in the steps S708 and S710 of the information processing method S7. Note, however, that the process of generating the common user list Ui\hat{ }glb may be carried out in this step S903 of the information processing method S9, and then the common user list Ui\hat{ }glb may be transmitted.

In the step S904, the client apparatus 100-i stores the received common data COM in the storage section 120-i. In the step S905, the server apparatus 200 stores the received common data COM in the storage section 220.

(Federated Learning Method S10)

The federated learning method S10 is a method carried out by the n client apparatuses 100-i and the server apparatus 200. Here, before the federated learning method S10 is described, the following symbol is explained. Any matrix M and sets G and H are expressed as follows.

M[G,I]:=(M[u,v])_{u∈G,v∈H}

Note, here, that M[u, v] represents a (u, v) component of M. Further, with regard to i=1, . . . , n, Ui\hat{ }bar and Vi\hat{ }bar are defined as follows.

Ūᵢ:=Uᵢ∪Qᵢ

V̅ᵢ:=Vᵢ∪Pᵢ

That is, Ui\hat{ }bar is a list obtained by combining the user list Ui and the commodity attribute list Qi. Vi\hat{ }bar is a list obtained by combining the commodity list Vi and the user attribute list Pi. Ui\hat{ }bar indicates the rows of the matrix Ri\hat{ }bar illustrated in FIG. 8. Vi\hat{ }bar indicates the columns of the matrix Ri\hat{ }bar.

E[u, v] is defined as the following formula (1).

$$\\ \begin{matrix}E [ u , v ] = \frac{{\sum }_{( s , t ) ∈ ESet [ u , v ]} \frac{r [ u , t ] S [ s , v ]}{R [ s , t ]}}{\#ESet [ u , v ]} & ( 1 )\end{matrix}$$

U∈Q, v∈P

Here, the following formula (2) holds true.

ESet[u,v]={(s,t)∈uᵢUᵢ×uᵢVᵢ|T[u,t]S[s,v], and R[s,t] are each not NULL} (2)

Further, among E[u, v], a part relating to the client apparatus 100-i (i.e., a part corresponding to E[Qi, Pi]) is referred to as Ei[u, v]. That is, Ei[u, v] is defined as follows.

Eᵢ[u,v]=E[u,v] if (u,v)∈Qᵢ×Pᵢ

Moreover, Ri\hat{ }bar[u, v] is defined as the following formula (3).

With respect to (u,v)∈Ūᵢ×V̅ᵢ,

$$\\ \begin{matrix}{\overline{R}}_{i} [ u , v ] := \{ \begin{matrix}{R}_{i} [ u , v ] & if ( u , v ) ∈ {U}_{i} \times {V}_{i} \\ {S}_{i} [ u , v ] & if ( u , v ) ∈ {U}_{i} \times {P}_{i} \\ {T}_{i} [ u , v ] & if ( u , v ) ∈ {Q}_{i} \times {V}_{i} \\ {E}_{i} [ u , v ] & if ( u , v ) ∈ {Q}_{i} \times {P}_{i}\end{matrix} & ( 3 )\end{matrix}$$

Here, a purpose of the federated learning method S10 is to determine Ai[Ui\hat{ }bar, K] and Bi[K, Vi\hat{ }bar] which are such that a product of Ai[u, K] and Bi[K, v] is substantially equal to Ri\hat{ }bar[u, v] with respect to an element (u, v) of Ui\hat{ }bar×Vi\hat{ }bar. In a case where this is expressed by a matrix, it can be said to find Ai[Ui\hat{ }bar, K] and Bi[K, Vi\hat{ }bar] which satisfy the following formula (4), with respect to each component that is included in Ri\hat{ }bar[Ui\hat{ }bar, Vi\hat{ }bar] and that is not a missing value.

Aᵢ[Ūᵢ,K]Bᵢ[K,V̅ᵢ]≈R̅[Ūᵢ,V̅ᵢ] (4)

In a case where this is rephrased with use of the above formula (3) and the definitions of Ui, Vi, Pi, and Qi, it can be said to find Ai[Ui\hat{ }bar, K] and Bi[K, Vi\hat{ }bar] expressed as follows.

With respect to u∈Uᵢ, v∈V̅ᵢ,

$$\\ {A}_{i} [ u , K ] {B}_{i} [ K , v ] \approx \{ \begin{matrix}{R}_{i} [ u , v ] if u is a user ID and v is a commodity ID \\ {S}_{i} [ u , v ] if u is a user and v is a user attribute \\ {T}_{i} [ u , v ] if u is a commodity attribute and v is a commodity ID \\ {E}_{i} [ u , v ] if u is a commodity attribute and v is a user attribute\end{matrix}$$

Note that ≈

represents being approximate.

This can be also expressed as the following formula (5).

Aᵢ[Uᵢ,K]Bᵢ[K,Vᵢ]≈R̅ᵢ[Uᵢ,Vᵢ]=Rᵢ[Uᵢ,Vᵢ]

Aᵢ[Uᵢ,K]Bᵢ[K,Pᵢ]≈R̅ᵢ[Uᵢ,Pᵢ]=Sᵢ[Uᵢ,Pᵢ]

Aᵢ[Qᵢ,K]Bᵢ[K,Vᵢ]≈R̅ᵢ[Qᵢ,Vᵢ]=Rᵢ[Qᵢ,Vᵢ]

Aᵢ[Qᵢ,K]Bᵢ[K,Pᵢ]≈R̅ᵢ[Qᵢ,Pᵢ]=Eᵢ[Qᵢ,Pᵢ] (5)

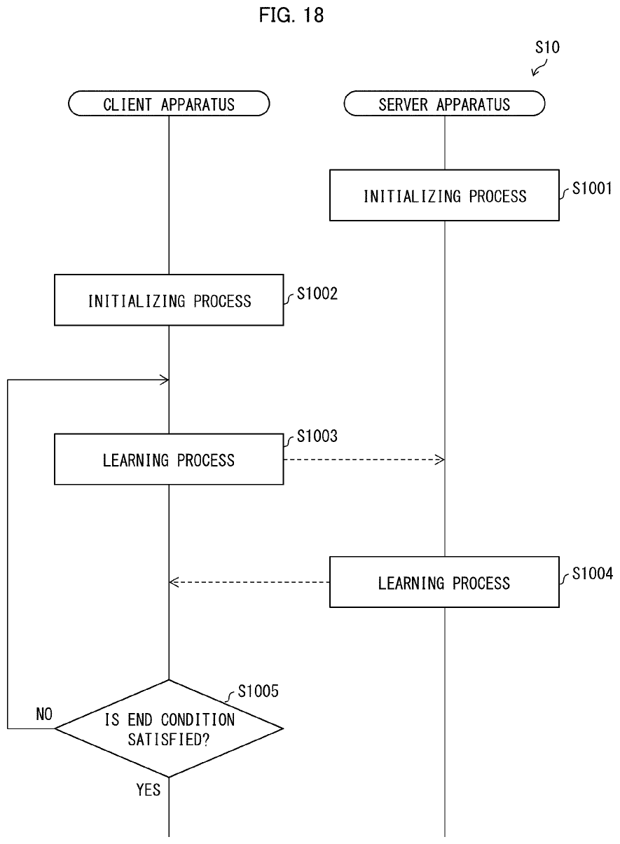

The symbols defined as above are used to describe the federated learning method S10 in accordance with the present example embodiment with reference to FIG. 18. FIG. 18 is a flowchart illustrating a flow of the federated learning method S10. For example, the federated learning method S10 is carried out when the client apparatus 100-i receives the training data set DSi and the common data COM from the servicer apparatus 300-i. As illustrated in FIG. 18, the federated learning method S10 includes steps S1001 to S1010.

In the step S1001, the server apparatus 200 carries out an initializing process. Details of this step are described later with reference to another drawing.

In the step S1002, each client apparatus 100-i carries out an initializing process. Details of this step are described later with reference to another drawing.

In the step S1003, each client apparatus 100-i carries out a learning process, and transmits the vectors Ai\hat{ }glb and Bi\hat{ }glb to the server apparatus 200 as the first parameter information. Details of this step are described later with reference to another drawing.

In the step S1004, the server apparatus 200 carries out a learning process, and transmits the vectors A\hat{ }glb and B\hat{ }glb to each client apparatus 100-i as the integrated parameter information. Details of this step are described later with reference to another drawing.

In the step S1005, each client apparatus 100-i determines whether or not an end condition is satisfied. In a case where the client apparatus 100-i makes a determination of YES, the client apparatus 100-i ends the client learning process. In a case where the client apparatus 100-i makes a determination of NO, the client apparatus 100-i repeats the processes from the step S1003. In this case, the server apparatus 200 repeats the process in the step S1004. Note that the end condition is, for example, such that, in each of the n client apparatuses 100-i, a loss function defined by the following formula (6) is smaller than a threshold.

Lᵢ(Rᵢ,Aᵢ,Bᵢ,λ,τ) (6)

In this case, in the step S1003, the client apparatus 100-i calculates a value of the loss function by formula (6) or the like, in addition to the vectors Ai\hat{ }glb and Bi\hat{ }glb, and transmits the value to the server apparatus 200. In the step S1004, in a case where values of the loss function which have been received from the respective n client apparatuses 100-i are each smaller than the threshold, the server apparatus 200 transmits, to each client apparatus 100-i, information indicating that the end condition is satisfied, in addition to the vectors A\hat{ }glb and B\hat{ }glb.

Note that the loss function in the end condition is not limited to the above formula (6). Note also that the end condition is not limited to the example in which the loss function is used, and may be, for example, such that the client learning process is repeated a given number of times.

(Server initializing method S11)

Next, a server initializing method S11 is described. The server initializing method S11 is a method for the server apparatus 200 to carry out the initializing process in the step S1001. Here, before the server initializing method S11 is described, the following symbols are explained.

Uᵢ^{loc}=Uᵢ\Uᵢ^{glb}

Vᵢ^{loc}=Vᵢ\Vᵢ^{glb}

Pᵢ^{loc}=Pᵢ\Pᵢ^{glb}

Qᵢ^{loc}=Qᵢ\Qᵢ^{glb} (7)

In formula (7), a difference set Ui\hat{ }loc obtained by subtracting the common user list Ui\hat{ }glb from the user list Ui represents a list of user IDs each of which is unique to each servicer apparatus 300-i (unique user ID list). A difference set Vi\hat{ }loc obtained by subtracting the common commodity list Vi\hat{ }glb from the commodity list Vi represents commodity IDs each of which is unique to each servicer apparatus 300-i (unique commodity list). A difference set Pi\hat{ }loc obtained by subtracting the common user attribute list Pi\hat{ }glb from the user attribute list Pi represents user attribute IDs each of which is unique to each servicer apparatus 300-i (unique user attribute list). A difference set Qi\hat{ }loc obtained by subtracting the common commodity attribute list Qi\hat{ }glb from the commodity attribute list Qi represents commodity attribute IDs each of which is unique to each servicer apparatus 300-i (unique commodity attribute list). Further, symbols are defined as the following formula (8).

Ūᵢ^{loc}=Uᵢ^{loc}∪Qᵢ^{loc}

V̅ᵢ^{loc}=Vᵢ^{loc}∪Pᵢ^{loc}

Ūᵢ^{glb}=Uᵢ^{glb}∪Qᵢ^{glb}

V̅ᵢ^{glb}=Vᵢ^{glb}∪Pᵢ^{glb} (8)

Note, here, that Ui\hat{ }bar\hat{ }loc and Vi\hat{ }bar\hat{ }loc are parameter information which should be concealed by the client apparatus 100-i, and Ui\hat{ }bar\hat{ }glb and Vi\hat{ }bar\hat{ }glb are the first parameter information disclosed to the server apparatus 200 by the client apparatus 100-i. Moreover, symbols are defined as the following formula (9).

Ū^{glb}=U_{i=1, . . . ,n}Ūᵢ^{glb}

V̅^{glb}=U_{i=1, . . . ,n}Ūᵢ^{glb}

In formula (9), U\hat{ }bar\hat{ }glb and V\hat{ }bar\hat{ }glb are respectively union sets of Ui\hat{ }bar\hat{ }glb and Vi\hat{ }bar\hat{ }glb disclosed from each client apparatus 100-i to the server apparatus 200. Here, as shown in formula (4), the purpose of the learning is to determine Ai[Ui\hat{ }bar, K] and Bi[K, Vi\hat{ }bar]. In the federated learning method S10, Ai[Ui\hat{ }bar\hat{ }glb, K] and Bi[K, Vi\hat{ }bar\hat{ }glb] which are respectively submatrices of Ai[Ui\hat{ }bar, K] and Bi[K, Vi\hat{ }bar] are transmitted and received between the client apparatus 100-i and the server apparatus 200. Ai[Ui\hat{ }bar\hat{ }loc, K] and Bi[K, Vi\hat{ }bar\hat{ }loc] which are respectively submatrices constituting remainders are held by the client apparatus 100-i, and are not transmitted to the server apparatus 200. Here, Ai[Ui\hat{ }bar\hat{ }glb, K] and Bi[K, Vi\hat{ }bar\hat{ }glb] are expressed as follows.

Aᵢ[Ūᵢ^{glb},K]=Aᵢ[Uᵢ^{glb}∪Qᵢ^{glb},K]

Bᵢ[K,V̅ᵢ^{glb}]=Bᵢ[K,Vᵢ^{glb}∪Pᵢ^{glb}]

Therefore, information transmitted and received between the client apparatus 100-i and the server apparatus 200 is expressed as the following formula (10).

Aᵢ[Uᵢ^{glb},K], Aᵢ[Qᵢ^{glb},K], Bᵢ[K,Vᵢ^{glb}], Bᵢ[K,Pᵢ^{glb}] (10)

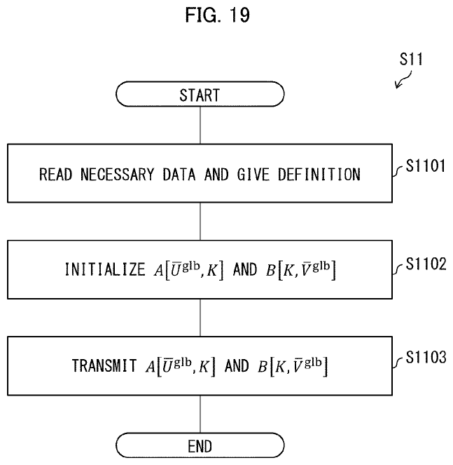

The symbols defined as above are used to describe the server initializing method S11 with reference to FIG. 19. FIG. 19 is a flowchart illustrating a flow of the server initializing method S11. As illustrated in FIG. 19, the server initializing method S11 includes steps S1101 to S1103.

In the step S1101, the control section 210 of the server apparatus 200 reads the hyperparameter k from the storage section 220, and sets K={1, . . . , k}. The control section 210 also reads, from the storage section 220, the common user lists U1\hat{ }bar\hat{ }glb, . . . , Un\hat{ }bar\hat{ }glb, and calculates U\hat{ }bar\hat{ }glb in accordance with formula (8).

In the step S1102, the control section 210 initializes A[U\hat{ }bar\hat{ }glb, K] and B[K, V\hat{ }bar\hat{ }glb] which are the integrated parameter information. Initializing refers to, but is not limited to, setting each component of these vectors to a random value, setting all components of these vectors to zero, etc.

In the step S1103, the control section 210 transmits, to each of the n client apparatuses 100-i, A[U\hat{ }bar\hat{ }glb, K] and B[K, V\hat{ }bar\hat{ }glb] as initial integrated parameter information. The integrated parameter information transmitted to each of the client apparatuses 100-i is also referred to as A[Ui\hat{ }bar\hat{ }glb, K] and B[K, Vi\hat{ }bar\hat{ }glb].

(Client Initializing Method S12)

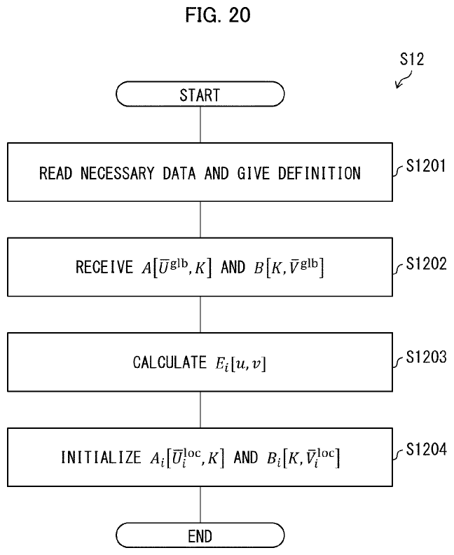

Next, a client initializing method S12 is described. The client initializing method S12 is a method for the client apparatus 100-i to carry out the initializing process in the step S1002. FIG. 20 is a flowchart illustrating a flow of the client initializing method S12. As illustrated in FIG. 20, the client initializing method S12 includes steps S1201 to S1204.

In the step S1201, the control section 110-i of the client apparatus 100-i reads the hyperparameter k from the storage section 120-i, and sets K={1, . . . , k}. The control section 110-i also reads the user list Ui, the commodity list Vi, the user attribute list Pi, and the commodity attribute list Qi from the storage section 120-i.

The control section 110-i further reads, from the storage section 120-i, one or more components Ri[u, v] which are not missing values in the evaluation value matrix Ri, one or more components Si[u, v] which are not missing values in the user attribute value matrix Si, and one or more components Ti[u, v] which are not missing values in the commodity attribute value matrix Ti.

The control section 110-i further reads, from the storage section 120-i, the common user list Ui\hat{ }glb, the common commodity list Vi\hat{ }glb, the common user attribute list Pi\hat{ }glb, and the common commodity attribute list Qi\hat{ }glb. The control section 110-i calculates the unique user list Ui\hat{ }loc, the unique commodity list Vi\hat{ }loc, the unique user attribute list Pi\hat{ }loc, and the unique commodity attribute list Qi\hat{ }loc in accordance with formula (7).

The control section 110-i also calculates Vi\hat{ }bar\hat{ }loc, Vi\hat{ }bar\hat{ }glb, Ui\hat{ }bar\hat{ }loc, and Ui\hat{ }bar\hat{ }glb, in accordance with formula (8).

In the step S1202, the control section 110-i receives A[Ui\hat{ }bar\hat{ }glb, K] and B[K, Vi\hat{ }bar\hat{ }glb] from the server apparatus 200. These pieces of information are information transmitted in the step S1103.

In the step S1203, the control section 110-i carries out a relevance value calculating process so as to calculate one or more components Ei[u, v] which are not missing values in the relevance value matrix Ei. Details of this step are described later.

In the step S1204. the control section 110-i initializes the vectors Ai[Ui\hat{ }bar\hat{ }loc, K] and Bi[K, Vi\hat{ }bar\hat{ }loc]. Initializing refers to, but is not limited to, setting each component of these vectors to a random value, setting all components of these vectors to zero, etc. The control section 110-i also calculates Ai[Ui\hat{ }bar, K] and Bi[K, Vi\hat{ }bar] in accordance with the following formula (11).

Aᵢ[Ūᵢ,K]=Aᵢ[Ūᵢ^{loc}∪Uᵢ^{glb},K]

Bᵢ[K,V̅ᵢ]=Bᵢ[K,V̅ᵢ^{loc}∪V̅ᵢ^{glb}] (11)

(Client learning method S13)

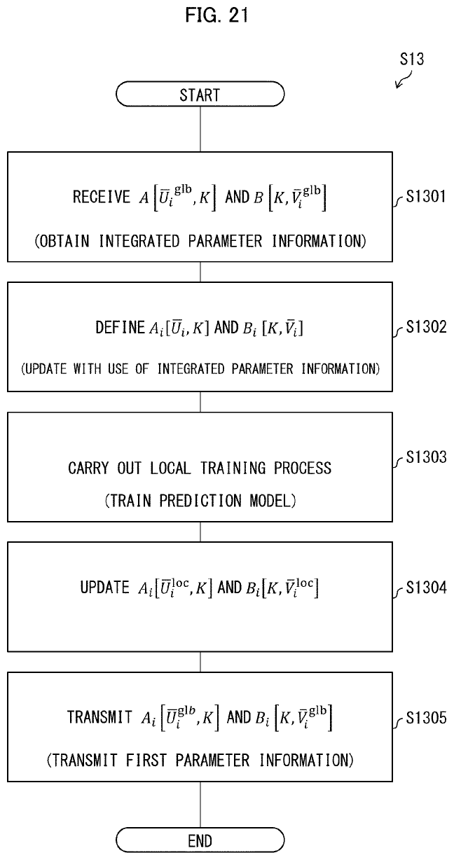

Next, a client learning method S13 is described. The client learning method S13 is a method for each client apparatus 100-i to carry out the learning process in the step S1003. FIG. 21 is a flowchart illustrating a flow of the client learning method S13. As illustrated in FIG. 21, the client learning method S13 includes steps S1301 to S1305.

In the step S1301, the parameter information obtaining section 113-i receives, from the server apparatus 200, A[U\hat{ }bar\hat{ }glb, K] and B[K, V\hat{ }bar\hat{ }glb] which are the integrated parameter information. Note, however, that in the first loop of the client learning method S13, the parameter information obtaining section 113-i uses the integrated parameter information received in the server initializing method S11, instead of receiving the integrated parameter information from the server apparatus 200.

In the step S1302, the updating section 114-i replaces, with the integrated parameter information A[Ui\hat{ }bar\hat{ }glb, K] and B[K, Vi\hat{ }bar\hat{ }glb], the first parameter information included in the plurality of vectors Ai[Ui\hat{ }bar, K] and Bi[K, Vi\hat{ }bar]. Thus, the plurality of vectors Ai[Ui\hat{ }bar, K] and Bi[K, Vi\hat{ }bar] as the prediction model MLi are updated. Specifically, the training section 111-i calculates the plurality of vectors Ai[Ui\hat{ }bar, K] and Bi[K, Vi\hat{ }bar] in accordance with the following formula (12).

Aᵢ[Ūᵢ^{glb},K]:=A[Ūᵢ^{glb},K]

Aᵢ[Ūᵢ,K]=Aᵢ[Ūᵢ^{loc}∪Ūᵢ^{glb},K]

Bᵢ[K,V̅ᵢ^{glb}]:=B[K,V̅ᵢ^{glb}]

Bᵢ[K,V̅ᵢ]=Bᵢ[K,V̅ᵢ^{loc}∪V̅ᵢ^{glb}] (12)

In the step S1303, the training section 111-i carries out a local learning process with use of the matrix Ri\hat{ }bar[u, v] and with use of Ai[Ui\hat{ }bar, K], Bi[K, Vi\hat{ }bar], and Ri\hat{ }bar[Ui\hat{ }bar, Vi\hat{ }bar] as inputs. The local learning process is a process of determining, by learning, Ai[Ui\hat{ }bar, K] and Bi[K, Vi\hat{ }bar] which functions as the prediction model MLi. The local learning process is a process of updating Ai[Ui\hat{ }bar, K] and Bi[K, Vi\hat{ }bar] so that approximation in formula (5) becomes more accurate. Details of the local learning process are described later.

In the step S1304, the training section 111-i updates Ai[Ui\hat{ }bar\hat{ }loc, K] to Ai\hat{ }new[Ui\hat{ }bar\hat{ }loc, K] with use of a result of the local learning process. The training section 111-i also updates Bi[K, Vi\hat{ }bar\hat{ }loc] to Bi\hat{ }new[K, Vi\hat{ }bar\hat{ }loc].

In the step S1305, the training section 111-i transmits, to the server apparatus 200, Ai\hat{ }new[Ui\hat{ }bar\hat{ }glb, K] and Bi\hat{ }new[K, Vi\hat{ }bar\hat{ }glb] as the first parameter information, with use of the result of the local learning process.

(Server Learning Method S14)

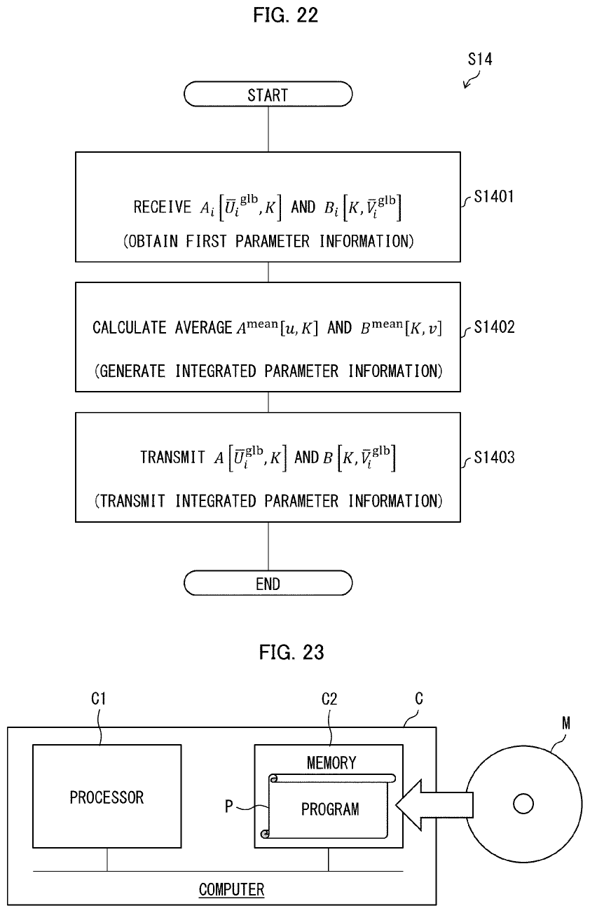

Next, a server learning method S14 is described. The server learning method S14 is a method for the server apparatus 200 to carry out the learning process in the step S1004. FIG. 22 is a flowchart illustrating a flow of the server learning method S14. As illustrated in FIG. 22, the server learning method S14 includes steps S1401 to S1405.

In the step S1401, the parameter information obtaining section 211 receives, from each client apparatus 100-i, Ai\hat{ }new[Ui\hat{ }bar\hat{ }glb, K] and Bi\hat{ }new[K, Vi\hat{ }bar\hat{ }glb] as the first parameter information.

In the step S1402, the integrating section 212 generates the integrated parameter information by integrating the received first parameter information in accordance with the following formula (13). Here, as an integrating method, a method of calculating an average of elements of the received first parameter information is used. However, the integrating method is not limited to this example.

$$\\ \begin{matrix}With respect to u ∈ \overline{U} {}^{glb} , & ( 13 )\end{matrix}$$

$$\\ {A}^{mean} [ u , K ] = \frac{{\sum }_{i ∈ \{ 1 , … , n ) s . t . u ∈ {\overline{U}}_{i}^{glb}} {A}_{i}^{new} [ u , K ]}{\# \{ i ∈ \{ 1 , … , n \} s . t . u ∈ \overline{U} {}_{i}^{{}^{} glb} \}}$$

$$\\ With respect to v ∈ \overline{V} {}^{glb} ,$$

$$\\ {B}^{{}^{} mean} [ K , v ] = \frac{{\sum }_{i ∈ \{ 1 , … , n ) s . t . v ∈ {\overline{V}}_{i}^{glb}} {B}_{i}^{{}^{} new} [ K , v ]}{\# \{ i ∈ \{ 1 , … , n \} s . t . v ∈ \overline{V} {}_{i}^{{}^{} glb} \}}$$

Thus, the integrating section 212 updates A[u, K] to A\hat{ }mean[u, K], and updates B[K, v] to B\hat{ }mean[K, v].

In the step S1403, the parameter information transmitting section 213 transmits, to each client apparatus 100-i, A[Ui\hat{ }bar\hat{ }glb, K] and B[K, Vi\hat{ }bar\hat{ }glb] which are the integrated parameter information, with use of a calculation result in the step S1402.

(Predicting Method S15)

Next, a predicting method which is carried out by the servicer apparatus 300-i with use of the prediction model MLi is described.

First, the servicer apparatus 300-i receives, from the client apparatus 100-i, A[Ui\hat{ }bar, K] and B[K, Vi\hat{ }bar] which function as the prediction model MLi, and stores A[Ui\hat{ }bar, K] and B[K, Vi\hat{ }bar] in the storage section 320-i. The predicting section 317-i of the servicer apparatus 300-i calculates a predicted value in accordance with the following formula (14) with use of u and v as inputs.

\hat{R}ᵢ[u,v]=Aᵢ[u,K]Bᵢ[K,v] (14)

Here, in a case where (u, v) is a component belonging to Ui×Vi, the predicted value indicated by formula (14) indicates a predicted value of the evaluation value Ri[u, v] of the user u with respect to the commodity v.

In a case where (u, v) is a component belonging to Ui×Pi, the predicted value indicated by formula (14) indicates a predicted value of the user attribute value Si[u, v] which is of the user attribute v and which is possessed by the user u.

In a case where (u, v) is a component belonging to Qi×Vi, the predicted value indicated by formula (14) indicates a predicted value of the commodity attribute value Ti[u, v] which is of the commodity attribute u and which is possessed by the commodity v.

In a case where (u, v) is a component belonging to Qi×Pi, the predicted value indicated by formula (14) indicates a predicted value of the relevance value Ei[u, v] of the commodity attribute u and the user attribute v.

For example, the servicer apparatus 300-i may use appropriate (u, v) as an input, depending on which of the above four types of predicted values is desired to be known, and calculate the predicted value in accordance with formula (14).

For example, a case is described where it is desired to deliver an advertisement of a commodity to the user u belonging to the user list Ui. In this case, the servicer apparatus 300-i predicts, in accordance with formula (14), an evaluation value with regard to a commodity which is included in the commodity list Vi and with respect to which the evaluation value of the user u is not obtained. The servicer apparatus 300-i delivers an advertisement to the user u in accordance with the predicted evaluation value. For example, the servicer apparatus 300-i may deliver an advertisement of a commodity having the highest evaluation value or may deliver advertisements of commodities in descending order of evaluation values.

For example, in a case where a user attribute value of the user attribute v is unknown with regard to the user u belonging to user list Ui, the servicer apparatus 300-i can obtain a predicted value of the user attribute value in accordance with formula (14). Thus, the servicer apparatus 300-i can improve the service provided to the user u, in accordance with the predicted value of the user attribute value.

For example, in a case where a commodity attribute value of the commodity attribute u is unknown with regard to the commodity v belonging to the commodity list Vi, the servicer apparatus 300-i can obtain a predicted value of the commodity attribute value in accordance with formula (14). Thus, the servicer apparatus 300-i can improve, for example, a plan of receiving the commodity v, in accordance with the predicted value of the commodity attribute value.

For example, the relevance value Ei[u, v] indicates an average of evaluation values which are given to a commodity of the commodity attribute v by users having the user attribute u. Therefore, by obtaining a predicted value of the relevance value Ei[u, v], it is possible to predict how much the user attribute u affects evaluation of the commodity of the commodity attribute v. That is, it is possible to predict a commodity of what commodity attribute is purchased by a user of what user attribute. This prediction result can be used to draft a commodity strategy.

(Detailed Example of Relevance Value Calculating Process)

A detailed example of the relevance value calculating process in the step S1203 is described. In formula (2) which defines Ei[u, v], information which is not possessed by the client apparatus 100-i is included in a subscript of the sum. Therefore, the client apparatus 100-i cannot calculate Ei[u, v] by itself, and needs cooperation of the other client apparatuses 100-j. As a method of calculating Ei[u, v], there is a method of using a secure computation, for example. As another method, for example, a calculation method as shown below is exemplified.

Definitions are given as follows.

$$\\ With respect to s ∈ U ,$$

$$\\ am ( s ) = \{ \begin{matrix}minimum j that satisfies s ∈ {U}_{j} & if j that satisfies s ∈ {U}_{j} exists \\ ⊥ & otherwise\end{matrix}$$

$$\\ With respect to t ∈ V ,$$

$$\\ am ( t ) = \{ \begin{matrix}minimum j that satisfies t ∈ {V}_{j} & if j that satisfies t ∈ {V}_{j} exists \\ ⊥ & otherwise\end{matrix}$$

Then, with respect to i=1, . . . , n, the client apparatus 100-i carries out the following.

$$\\ With respect to ( u , v ) ∈ ( Q \times P ) \backslash ( {Q}_{i}^{{}^{} glb} \times {P}_{i}^{{}^{} glb} ) ,$$

$$\\ {E}_{i} [ u , v ] = E [ u , v ] = \frac{{\sum }_{( s , t ) ∈ ESet [ u , v , i ]} \frac{r [ u , t ] S [ s , v ]}{R [ s , t ]}}{\#ESet [ u , v , i ]}$$

is defined. Here,

ESet[u,v,i]={(s,t)∈Uᵢ×Vᵢ|T[u,t]S[s,v], and R[s,t] are each not NULL}

### Thus,

with respect to

(u,v)∈Qᵢ^{glb}×Pᵢ^{glb},

the following is carried out.

ESet′[u,v]={(s,t)∈Uᵢ×Vᵢ|T[u,t]S[s,v], and R[s,t] are each not ⊥ and am(s)=i, am(t)=i}

is defined.

$$\\ {Numer}_{i} [ u , v ] = {\sum }_{( s , t ) ∈ ESet ′ [ u , v , i ]} \frac{T [ u , t ] S [ s , v ]}{R [ s , t ]}$$

is calculated. Further,

Denomᵢ[u,v]=#ESet′[u,v,i]

is calculated. The client apparatus 100-i transmits

Numerᵢ[u,v], Denomᵢ[u,v]

to the server apparatus 200.

Next, the server apparatus 200 carries out the following.

$$\\ With respect to each ( u , v ) ∈ {Q}^{glb} \times {P}^{glb} ,$$

$$\\ E [ u , v ] = \frac{{\sum }_{i} {Numer}_{i} [ u , v ]}{{\sum }_{i} {Denom}_{i} [ u , v ]}$$

is calculated.
With respect to each (u,v)∈Qᵢ^{glb}×Pᵢ^{glb}, E[u,v]
is transmitted to the client apparatus 100-i.
Each client apparatus 100-i sets the received E[u, v] to Ei[u, v].

(Detailed Example of Local Learning Process)

Next, a detailed example of the local learning process in the step S1303 is described. Specifically, a purpose of the local learning process is to update the vectors Ai and Bi so that a difference between Ri\hat{ }bar and a product of the vectors Ai and Bi becomes small. Therefore, a loss function which evaluates how different these are is introduced, and learning is conducted so that the loss function becomes small. As such a learning method, for example, a gradient descent method is, for example, known. Here, a detailed example in which a square error is used as the loss function and the gradient descent method is used as the learning method is described.

First, with respect to sets G and H, a condition I, and a numerical value a[u, v], the following definition is given.

$$\\ Sum ( u ∈ G , v ∈ H , s . t . I ( u , v ) ) ( a [ u , v ] ) = {\sum }_{u ∈ G , v ∈ H , s . t . I ( u , v )} a [ u , v ]$$

$$\\ {N}_{i} [ G , H ] := Sum ( u ∈ G , v ∈ H , s . t . {\overline{R}}_{i} [ u , v ] \neq ⊥ ) ( {‖ {\overline{R}}_{i} [ u , v ] - {A}_{i} [ u , K ] {B}_{i} [ K , v ] ‖}^{2} )$$

At this time, for example, the following function can be used as the loss function.

Lᵢ(\ddot{R}ᵢ,Aᵢ,Bᵢ,λ,τ)=λₗ^{Rll}Nᵢ[Uₗ^{loc},Vᵢ^{loc}]+λᵢ^{Rlg}Nᵢ[Uᵢ^{loc},Vᵢ^{glb}]+λᵢ^{Sll}Nᵢ[Uᵢ^{loc},Pᵢ^{loc}]+λᵢ^{Slg}Nᵢ[Uᵢ^{loc},Pᵢ^{glb}]+λᵢ^{Rgl}Nᵢ[Uᵢ^{glb},Vᵢ^{loc}]+λᵢ^{Rgg}Nᵢ[Uᵢ^{glb},Vᵢ^{glb}]+λᵢ^{Sgl}Nᵢ[Uᵢ^{glb},Pᵢ^{loc}]+λᵢ^{Sgg}Nᵢ[Uᵢ^{glb},Pᵢ^{glb}]+λᵢ^{Tll}Nᵢ[Qᵢ^{loc},Vᵢ^{loc}]+λᵢ^{Tlg}Nᵢ[Qᵢ^{loc},Vᵢ^{glb}]+λᵢ^{Ell}Nᵢ[Qᵢ^{loc},Pᵢ^{loc}]+λᵢ^{Elg}Nᵢ[Qᵢ^{loc},Pᵢ^{gib}]+λᵢ^{Tgl}Nᵢ[Qᵢ^{glb},Vᵢ^{loc}]+λₗ^{Tgg}Nᵢ[Qᵢ^{glb},Vᵢ^{glb}]+λᵢ^{Egl}Nᵢ[Qᵢ^{glb},Pᵢ^{loc}]λᵢ^{Egg}Nᵢ[Qᵢ^{glb},Pᵢ^{glb}]+L′ᵢ(R̅ᵢ,Aᵢ,Bᵢ,τ)

Here, λᵢ=(λᵢ^{Rll},λᵢ^{Rlg},λᵢ^{Sll},λᵢ^{Slg},λᵢ^{Rgl},λᵢ^{Rgg},λᵢ^{Sgl},λᵢ^{Sgg},λᵢ^{Tll},λᵢ^{Tlg},λᵢ^{Ell}, λᵢ^{Elg},λᵢ^{Tgl},λᵢ^{Tgg},λᵢ^{Egl},λᵢ^{Egg}) is a value for determining which term is focused on to what extent. In this detailed example, it is assumed that the value is determined in advance by the client apparatus 100-i and is stored in the storage section 120-i. Further, is a term referred to as a “regularization term” for preventing over-learning. The term may be set to zero if the term is not necessary. If the term is necessary, a term calculated, for example, as follows may be used.

L′ᵢ(R̅ᵢ,Aᵢ,Bᵢ,τ)=τᵢ^{Ul}Sum(u∈Uᵢ^{loc},k∈K)(∥Aᵢ[u,k]∥²)+τᵢ^{Ug}Sum(u∈Uᵢ^{glb},k∈K)(∥Aᵢ[u,k]∥²)+τᵢ^{Ql}Sum(u∈Qᵢ^{loc},k∈K)(∥Aᵢ[u,k]∥²)+τᵢ^{Qg}Sum(u∈Qᵢ^{loc},k∈K)(∥Aᵢ[u,k]∥²)+τᵢ^{Pl}Sum(k∈K,v∈Pₗ^{loc})(∥Bᵢ[k,v]∥²)+τᵢ^{Pg}Sum(k∈K,v∈Pᵢ^{glb})(∥Bᵢ[k,v]∥²)

Here,

τᵢ=(τᵢ^{Ul},τᵢ^{Ug},τᵢ^{Ql},τᵢ^{Qg},τᵢ^{Vl},τᵢ^{Vg},τᵢ^{Pl},τᵢ^{Pg})

is a value for determining which term is focused on to what extent. In this detailed example, it is assumed that the value is determined in advance by the client apparatus 100-i and is stored in the storage section 120-i. Further, there are various learning methods for reducing

Lᵢ(R̅ᵢ,Aᵢ,Bᵢλ,τ).

For example, the following method can be used.
The client apparatus 100-i reads λi, τi, LoopMax, and α from a hyperparameter storage section. Ai and Ti are expressed as follows.

λᵢ=(λᵢ^{Rll},λᵢ^{Rlg},λᵢ^{Sll},λᵢ^{Slg},λᵢ^{Rgl},λᵢ^{Rgg},λᵢ^{Sgl},λᵢ^{Sgg},λᵢ^{Tll},λᵢ^{Tlg},λᵢ^{Ell},λᵢ^{Elg},λᵢ^{Tgl},λᵢ^{Tgg},λᵢ^{Egl},λᵢ^{Egg})

τᵢ=(τᵢ^{Ul},τᵢ^{Ug},τᵢ^{Ql},τᵢ^{Qg},τᵢ^{Vl},τᵢ^{Vg},τᵢ^{Pl},τᵢ^{Pg})

The client apparatus 100-i repeats the following operation LoopMax times.

The client apparatus 100-i subtracts αDel(Li, Ai[u]) from Ai[u] with respect to each u belonging to Ui\hat{ }bar. Further, with respect to each v belonging to Vi\hat{ }bar, αDel(Li, Bi[v]) is subtracted from Vi[v]. Note that, instead of repeating the above process a given number of times, i.e., LoopMax times, the client apparatus 100-i may repeat the above process until

Lᵢ(R̅ᵢ,Aᵢ,Bᵢ,λ,λ)

becomes equal to or less than a certain value.
In the above case, α is a value referred to as a learning rate for adjusting how much learning is advanced. Del(f, C) represents a partial derivative of a function f with respect to a variable C. In a case where

Cᵢ^{u}[k,H]:=−2Sum(t∈s.t.Rᵢ[u,t])≠⊥)((R̅ᵢ[u,t]−Aᵢ[u,K]Bᵢ[K,t])Bᵢ[k,u])

τᵢ=(τᵢ^{Ul},τᵢ^{Ug},τᵢ^{Ql},τᵢ^{Qg},τᵢ^{Vl},τᵢ^{Vg},τᵢ^{Pl},τᵢ^{Pg})

are set with respect to the sets G and H, the following are specifically obtained in a case of the above Lᵢ(Rᵢ,Aᵢ,Bᵢ,λ,τ,τ), (L′ᵢ,Aᵢ,Bᵢ,τ).

$$\\ Del ( {L}_{i} , {A}_{i} [ u , k ] ) = \{ \begin{matrix}{λ}_{i}^{Ril} {C}_{i}^{u} [ {V}_{i}^{loc} ] + {λ}_{i}^{Rig} {C}_{i}^{u} [ {V}_{i}^{glb} ] + {λ}_{i}^{Sil} {C}_{i}^{u} [ {P}_{i}^{loc} ] + {λ}_{i}^{Sig} {C}_{i}^{u} [ {P}_{i}^{glb} ] + 2 {τ}_{i}^{Ui} {A}_{i} [ u , k ] & if u ∈ {U}_{i}^{{}^{} loc} \\ {λ}_{i}^{Rgl} {C}_{i}^{u} [ {V}_{i}^{loc} ] + {λ}_{i}^{Rgg} {C}_{i}^{u} [ {V}_{i}^{glb} ] + {λ}_{i}^{Sgl} {C}_{i}^{u} [ {P}_{i}^{loc} ] + {λ}_{i}^{Sgg} {C}_{i}^{u} [ {P}_{i}^{glb} ] + 2 {τ}_{i}^{Ug} {A}_{i} [ u , k ] & if u ∈ {U}_{i}^{{}^{} glb} \\ {λ}_{i}^{Til} {C}_{i}^{u} [ {V}_{i}^{loc} ] + {λ}_{i}^{Tig} {C}_{i}^{u} [ {V}_{i}^{glb} ] + {λ}_{i}^{Eil} {C}_{i}^{u} [ {P}_{i}^{loc} ] + {λ}_{i}^{Eig} {C}_{i}^{u} [ {P}_{i}^{glb} ] + 2 {τ}_{i}^{{}^{} Qi} {A}_{i} [ u , k ] & if u ∈ {Q}_{i}^{{}^{} loc} \\ {λ}_{i}^{Tgl} {C}_{i}^{u} [ {V}_{i}^{loc} ] + {λ}_{i}^{Tgg} {C}_{i}^{u} [ {V}_{i}^{glb} ] + {λ}_{i}^{Egl} {C}_{i}^{u} [ {P}_{i}^{loc} ] + {λ}_{i}^{Egg} {C}_{i}^{u} [ {P}_{i}^{glb} ] + 2 {τ}_{i}^{{}^{} Qg} {A}_{i} [ u , k ] & if u ∈ {Q}_{i}^{{}^{} glb}\end{matrix}$$

$$\\ Del ( {L}_{i} , {B}_{i} [ k , v ] ) = \{ \begin{matrix}{λ}_{i}^{Ril} {D}_{i}^{v} [ {V}_{i}^{loc} ] + {λ}_{i}^{Rgl} {D}_{i}^{v} [ {V}_{i}^{loc} ] + {λ}_{i}^{Til} {D}_{i}^{v} [ {V}_{i}^{loc} ] + {λ}_{i}^{Tgl} {D}_{i}^{v} [ {Q}_{i}^{glb} ] + 2 {τ}_{i}^{Vi} {B}_{i} [ k , v ] & if v ∈ {V}_{i}^{{}^{} loc} \\ {λ}_{i}^{Rig} {D}_{i}^{v} [ {V}_{i}^{glb} ] + {λ}_{i}^{Rgg} {D}_{i}^{v} [ {V}_{i}^{glb} ] + {λ}_{i}^{Tig} {D}_{i}^{v} [ {V}_{i}^{glb} ] + {λ}_{i}^{Tgg} {D}_{i}^{v} [ {V}_{i}^{glb} ] + 2 {τ}_{i}^{Vg} {B}_{i} [ k , v ] & if v ∈ {V}_{i}^{{}^{} glb} \\ {λ}_{i}^{Sil} {D}_{i}^{v} [ {P}_{i}^{loc} ] + {λ}_{i}^{Sgl} {D}_{i}^{v} [ {P}_{i}^{loc} ] + {λ}_{i}^{Eil} {D}_{i}^{v} [ {P}_{i}^{loc} ] + {λ}_{i}^{Egl} {D}_{i}^{v} [ {P}_{i}^{glb} ] + 2 {τ}_{i}^{{}^{} Pi} {B}_{i} [ k , v ] & if v ∈ {Q}_{i}^{{}^{} loc} \\ {λ}_{i}^{Sig} {D}_{i}^{v} [ {P}_{i}^{glb} ] + {λ}_{i}^{Sgg} {D}_{i}^{v} [ {P}_{i}^{glb} ] + {λ}_{i}^{Eig} {D}_{i}^{v} [ {P}_{i}^{glb} ] + {λ}_{i}^{Egg} {D}_{i}^{v} [ {P}_{i}^{glb} ] + 2 {τ}_{i}^{{}^{} Pg} {B}_{i} [ k , v ] & if v ∈ {Q}_{i}^{{}^{} glb}\end{matrix}$$

### Effects of the Present Example Embodiment

The federated learning system 10A in accordance with the present example embodiment employs a configuration such that: (i) the prediction model MLi, which predicts a missing evaluation value, is trained with use of the training data set DSi that includes the evaluation value matrix Ri, in which a part of the evaluation values each of which corresponds to a combination of one of the users in the user list Ui and one of the commodities in the commodity list Vi is missing, and the commodity attribute value matrix Ti, in which a part of the commodity attribute values each of which corresponds to a combination of one of the commodity attributes in the commodity attribute list Qi and one of the commodities in the commodity list Vi is missing; (ii) the first parameter information Ai\hat{ }new[Ui\hat{ }bar\hat{ }glb, K] and Bi\hat{ }new[K, Vi\hat{ }bar\hat{ }glb], which indicate at least a part of the prediction model MLi, is transmitted to the server apparatus 200; (iii) the integrated parameter information A[Ui\hat{ }bar\hat{ }glb, K] and B[K, Vi\hat{ }bar\hat{ }glb], which have been obtained by integrating the first parameter information obtained from the plurality of client apparatuses 100-i, are received from the server apparatus 200; and (iv) the prediction model MLi is updated by replacing the first parameter information with the integrated parameter information. According to the above configuration, while keeping the concealment of information among the plurality of client apparatuses 100-i, it is possible to more accurately predict an evaluation value of a user with respect to a commodity with use of the commodity attributes. Therefore, by using such a prediction model MLi, it is possible to generate information appropriate for a receiver of the information based on the predicted evaluation value.

The federated learning system 10A in accordance with the present example embodiment employs a configuration such that: the training data set DSi further includes the user attribute value matrix Si, in which a part of the user attribute values each of which corresponds to a combination of one of the users in the user list Ui and one of the user attributes in the user attribute list Pi is missing; and the prediction model MLi is trained with use of the training data set DSi. According to the above configuration, by further using the user attributes, it is possible to generate the prediction model MLi which more accurately predicts an evaluation value of a user with respect to a commodity.

The federated learning system 10A in accordance with the present example embodiment employs a configuration such that, between the client apparatuses 100-i and 100-j, the user lists Ui and Uj contain a mutually common user, the commodity lists Vi and Vj contain a mutually common commodity, the commodity attribute lists Qi and Qj contain a mutually common commodity attribute, and the user attribute lists Pi and Pj contain a mutually common user attribute. According to the above configuration, it is possible to even more accurately predict an evaluation value of a user with respect to a commodity, in consideration of the common user, the common commodity, the common commodity attribute, and the common user attribute. Further, it is also possible to cope with a case where there is a unique user, a unique commodity, a unique commodity attribute, or a unique user attribute in each client apparatus 100-i.

The federated learning system 10A in accordance with the present example embodiment employs a configuration such that: the training data set DSi is used as the matrix Ri\hat{ }bar, in which a part of the evaluation values each of which corresponds to a combination of one of the users and one of the commodities is missing; the plurality of vectors Ai[Ui\hat{ }bar, K] and Bi[K, Vi\hat{ }bar] obtained by decomposing the matrix Ri\hat{ }bar are determined as the prediction model MLi; and Ai\hat{ }new[Ui\hat{ }bar\hat{ }glb, K] and Bi\hat{ }new[K, Vi\hat{ }bar\hat{ }glb] which are respectively at least parts of the plurality of vectors are transmitted as the first parameter information. According to the above configuration, it is possible to generate the prediction model MLi that predicts an evaluation value with respect to a commodity with respect to which the evaluation value of a user is unknown.

The federated learning system 10A in accordance with the present example embodiment employs a configuration such that the plurality of vectors Ai[Ui\hat{ }bar, K] and Bi[K, Vi\hat{ }bar] are determined so that a component which is included in a product of the plurality of vectors and which corresponds to the other of the evaluation values that is not missing in the matrix Ri\hat{ }bar approximates to the other of the evaluation values. According to the above configuration, it is possible to generate the prediction model MLi that accurately predicts an evaluation value with respect to a commodity with respect to which the evaluation value of a user is unknown.

In the present example embodiment, a configuration is employed such that the plurality of vectors Ai[Ui\hat{ }bar, K] and Bi[K, Vi\hat{ }bar] are determined so that a component which is included in the product of the plurality of vectors and which corresponds to the other of the commodity attribute values that is not missing in the matrix Ri\hat{ }bar approximates to the other of the commodity attribute values. According to the above configuration, it is possible to generate the prediction model MLi that accurately predicts a commodity attribute value with respect to a commodity with respect to which the commodity attribute value is unknown.

The federated learning system 10A in accordance with the present example embodiment employs a configuration such that the plurality of vectors Ai[Ui\hat{ }bar, K] and Bi[K, Vi\hat{ }bar] are determined so that a component which is included in the product of the plurality of vectors and which corresponds to the other of the user attribute values that is not missing in the matrix Ri\hat{ }bar approximates to the other of the user attribute values. According to the above configuration, it is possible to generate the prediction model MLi that accurately predicts a user attribute value with respect to a user with respect to which the user attribute value is unknown.

The federated learning system 10A in accordance with the present example embodiment employs a configuration such that the plurality of vectors Ai[Ui\hat{ }bar, K] and Bi[K, Vi\hat{ }bar] are determined so that a component which is included in the product of the plurality of vectors and which corresponds to the other of the relevance values that is not missing in the matrix Ri\hat{ }bar approximates to the other of the relevance values. According to the above configuration, it is possible to accurately predict a relevance value which indicates relevance of a user attribute and a commodity attribute. This makes it possible to, for example, generate the prediction model MLi that predicts a commodity of what commodity attribute is purchased by a user of what user attribute.

The federated learning system 10A in accordance with the present example embodiment employs a configuration such that each of the relevance values is calculated based on a value obtained by dividing a product of one of the user attribute values and one of the target attribute values by one of the evaluation values which corresponds to the one of the user attribute values and the one of the target attribute values. According to the above configuration, it is possible to calculate a relevance value as training data for predicting relevance of a user attribute and a commodity attribute.

Further, in the federated learning system 10A in accordance with the present example embodiment, each client apparatus 100-i transmits, as the first parameter information, parameter information obtained based on, among information indicating the prediction model MLi, information common to the training data sets DSi and DSj. Note that the common information includes information indicating a common evaluation target, a common user, a common commodity attribute, or a common user attribute. According to the above configuration, each client apparatus 100-i does not transmit parameter information obtained based on unique information. Therefore, it is possible to keep the concealment of information among the client apparatuses 100-i.

In the federated learning system 10A in accordance with the present example embodiment, each servicer apparatus 300-i can predict an evaluation value corresponding to a combination of a user and an evaluation target which is not given the evaluation value, with use of the prediction model MLi. Moreover, each servicer apparatus 300-i can predict a user attribute value of a user with respect to a user attribute with respect to which the user attribute value is not obtained, with use of the prediction model MLi. Moreover, each servicer apparatus 300-i can predict a commodity attribute value of a commodity with respect to a commodity attribute with respect to which the commodity attribute value is not obtained, with use of the prediction model MLi. Moreover, each servicer apparatus 300-i can predict relevance of a user attribute and a commodity attribute, with use of the prediction model MLi.

According to the present example embodiment, it is possible to obtain an estimated value of an evaluation value of a commodity which is not yet given the evaluation value by a user. Therefore, it is possible to recommend, to a user, a commodity having a high estimated evaluation value. Moreover, according to the present example embodiment, as secondary effects, the following effects are brought about: (i) in a case where a user attribute of a user is unknown, it is possible to estimate the user attribute value; (ii) in a case where a commodity attribute value of a commodity is unknown, it is possible to estimate the commodity attribute value; and (iii) in a case where an average value of evaluation values which are given to a commodity having a commodity attribute of u by a user having a user attribute of v is unknown, it is possible to predict the average value. This makes it possible to predict a user attribute and a commodity attribute. Therefore, the servicer apparatus 300-i's understanding of a user and a commodity is enhanced, which leads to an improvement in a service provided by a company itself.

The “average value of evaluation values which are given to a commodity having a commodity attribute of u by a user having a user attribute of v” indicates relevance of the user attribute and the commodity attribute. Therefore, by predicting such an average value, it is possible to carry out an analysis about what type of user tends to purchase what type of commodity. This analysis result can be referred to when a new commodity is received, or can lead to an improvement in a service provided by a company itself.

The present example embodiment has merits (i) to (vi) that the present example embodiment can be used even in the following cases, contrary to the technique described in Non-Patent Literature 1.

(i) The present example embodiment operates even in a case where there is a user common to any of the client apparatuses 100-i.

(ii) The present example embodiment operates even in a case where there is a commodity unique to each client apparatus 100-i.

(iii) A user attribute can be used to predict an evaluation value.

(iv) A commodity attribute can be used to predict an evaluation value.

(v) The present example embodiment can deal with a user attribute and/or a commodity attribute common to any of the client apparatuses 100-i, and/or can deal with a user attribute and/or a commodity attribute unique to each client apparatus 100-i.

(vi) An improvement in accuracy by federated learning can be expected even in a case where neither of a user nor a commodity is common to any of the client apparatuses 100-i.

Here, the merit (vi) is described. In the technique disclosed in Non-Patent Literature 1, an improvement in accuracy by federated learning is carried out by causing transfer learning in which a user and/or a commodity common to any of a plurality of client apparatuses is used. Therefore, in a case where there is no user or commodity common to any of client apparatuses, the accuracy is not improved even if federated learning is conducted, as compared with a case where each client apparatus conducts learning individually.

In contrast, according to the present example embodiment, the relevance value matrix Ei is added to the components of Ri\hat{ }bar. Thus, in a case where there is a user attribute and/or a commodity attribute common to any of the client apparatuses 100-i, transfer learning occurs from the common user attribute and/or the common commodity attribute, and the accuracy is improved. Therefore, the present example embodiment has the merit that, even in a case where neither of a user nor a commodity is common to any of the client apparatuses 100-i, an improvement in accuracy by federated learning can be expected.

### Modifications

In the present example embodiment, an example has been described in which a commodity is applied as a target evaluated by a user. However, the evaluation target is not limited to this example. For example, another example of the evaluation target may be a seller, a manufacturer, or the like of a commodity. Further, the user who gives evaluation to the evaluation target is not limited to an end user who receives a service. For example, the user may be an intermediate user, such as a commodity purchaser, in a process of providing the service.

In the present example embodiment, the servicer apparatus 300-i is not limited to an apparatus which provides the sale service. The servicer apparatus 300-i may be an apparatus which provides another service. Examples of the another service include educational services, medical services, and video delivery services. In such cases, examples of the evaluation target may include schools, lectures, and teachers in the educational services, hospitals and doctors in the medical services, and videos in the video delivery services.

In the present example embodiment, the servicer apparatus 300-i and the client apparatus 100-i have been described as separate apparatuses. However, in a part or all of i=1 to n, these may be constituted by the same apparatus.

In the present example embodiment, an evaluation value with respect to a commodity has been described as being given by a user. However, the evaluation value of the user with respect to the commodity may be a value calculated by a computer on the basis of a user's action history (e.g., history of browsing a sale site) etc. For example, the evaluation value registering section 313-i may obtain an evaluation value estimated on the basis of the user's action history, instead of obtaining an evaluation value inputted by the user. The action history may be a browsing history, a purchase history, or the like in the sale service. For example, the evaluation value registering section 313-i may estimate a score 1 as an evaluation value in response to a fact that a user u has browsed a page relating to a commodity v. For example, the evaluation value registering section 313-i may estimate a score 10 as an evaluation value in response to a fact that the user u has purchased the commodity v. Note that this example indicates that, as a numerical value becomes higher, evaluation becomes higher, but the present example embodiment is not limited to this example. Moreover, a method of obtaining an evaluation value with respect to a commodity is not limited to the above-described method, and may be another method.

Similarly, a user attribute value has been described as being inputted by a user. However, the user attribute value may be a value calculated by a computer on the basis of a user's action history (e.g. history of browsing a sale site), another inputted content, etc. For example, the user registering section 311-i may obtain the user attribute value by estimating the user attribute value on the basis of a user's browsing history, purchase history, etc., instead of information inputted by the user.

Further, the present example embodiment can be modified so as to operate without use of the user attribute list Pi. In this case, the matrix Ri\hat{ }bar is modified so that the matrix Ri\hat{ }bar contains the evaluation value matrix Ri and the commodity attribute value matrix Ti and does not contain the user attribute matrix Si and the relevance value matrix Ei. The training section 111-i determines the plurality of vectors Ai[Ui\hat{ }bar, K] and Bi[K, Vi\hat{ }bar] so that components which are included in a product of the plurality of vectors and which respectively correspond to an evaluation value and a commodity attribute value that are not missing in such a matrix Ri\hat{ }bar respectively approximate to the evaluation value and the commodity attribute value. Even in this case, the present example embodiment brings about effects substantially similar to the above-described effects.

[Software Implementation Example]

A part or all of the functions of the federated learning apparatus 1, the client apparatus 100-i, the server apparatus 2, 200, and the servicer apparatus 300-i (hereinafter referred to each apparatus) may be realized by hardware such as an integrated circuit (IC chip) or may be alternatively realized by software.

In the latter case, each apparatus is realized by, for example, a computer that executes instructions of a program that is software realizing the functions. FIG. 23 illustrates an example of such a computer (hereinafter, referred to as “computer C”). The computer C includes at least one processor C1 and at least one memory C2. In the memory C2, a program P for causing the computer C to operate as each apparatus is recorded. In the computer C, the functions of each apparatus are realized by the processor C1 reading the program P from the memory C2 and executing the program P.

The processor C1 can be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 can be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface via which the computer C transmits and receives data to and from another apparatus. The computer C may further include an input/output interface via which the computer C is connected to an input/output apparatus such as a keyboard, a mouse, a display, and a printer.

The program P can also be recorded in a non-transitory tangible recording medium M from which the computer C can read the program P. Such a recording medium M can be, for example, a tape, a disk, a card, a semiconductor memory, a programmable logic circuit, or the like. The computer C can acquire the program P via such a recording medium M. The program P can also be transmitted via a transmission medium. Such a transmission medium can be, for example, a communication network, a broadcast wave, or the like. The computer C can acquire the program P via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional remark 2]

The whole or part of the example embodiments disclosed above can be described as follows. Note, however, that the present invention is not limited to the following Example Aspects.

(Supplementary Note 1)

A federated learning apparatus including:
a training means for training a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list;
a parameter information transmitting means for transmitting, to a server apparatus, first parameter information which indicates at least a part of the first prediction model;
a parameter information obtaining means for obtaining, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and
an updating means for updating the first prediction model by replacing the first parameter information with the integrated parameter information.

(Supplementary Note 2)

The federated learning apparatus described in Supplementary note 1, wherein:
the first training data set further includes user attribute values each of which is possessed by one of a part or all of the users in the user list and each of which relates to one of user attributes in a user attribute list; and
the training means trains the first prediction model with use of the first training data set.

(Supplementary Note 3)

The federated learning apparatus described in Supplementary note 2, wherein:
the user list included in the first training data set and the user list included in the second training data set include a mutually common user;
the evaluation target list included in the first training data set and the evaluation target list included in the second training data set include a mutually common evaluation target;
the target attribute list included in the first training data set and the target attribute list included in the second training data set include a mutually common target attribute; and
the user attribute list included in the first training data set and the user attribute list included in the second training data set include a mutually common user attribute.

(Supplementary Note 4)

The federated learning apparatus described in Supplementary note 1 or 2, wherein:
the training means uses the first training data set as a multidimensional array in which a part of evaluation values each of which corresponds to a combination of one of the users and one of the evaluation targets is missing, and determines, as the first prediction model, a plurality of vectors obtained by decomposing the multidimensional array; and
the parameter information transmitting means transmits at least a part of the plurality of vectors as the first parameter information.

(Supplementary Note 5)

The federated learning apparatus described in Supplementary note 4, wherein the training means determines the plurality of vectors so that a component which is included in a product of the plurality of vectors and which corresponds to the other of the evaluation values that is not missing in the multidimensional array approximates to the other of the evaluation values.

(Supplementary Note 6)

The federated learning apparatus described in Supplementary note 4 or 5, wherein:
in the multidimensional array, a part of target attribute values each of which corresponds to a combination of one of the target attributes and one of the evaluation targets is further missing, in addition to missing of the part of the evaluation values; and
the training means determines the plurality of vectors so that a component which is included in a product of the plurality of vectors and which corresponds to the other of the target attribute values that is not missing in the multidimensional array approximates to the other of the target attribute values.

(Supplementary Note 7)

The federated learning apparatus described in any one of Supplementary notes 4 through 6, wherein:
the first training data set further includes user attribute values each of which is possessed by one of a part or all of the users in the user list and each of which relates to one of user attributes in a user attribute list;
in the multidimensional array, a part of user attribute values each of which corresponds to a combination of one of the user attributes and one of the users is further missing, in addition to missing of the part of the evaluation values; and
the training means determines the plurality of vectors so that a component which is included in a product of the plurality of vectors and which corresponds to the other of the user attribute values that is not missing in the multidimensional array approximates to the other of the user attribute values.

(Supplementary Note 8)

The federated learning apparatus described in Supplementary note 7, wherein:
in the multidimensional array, a part of relevance values each of which corresponds to a combination of one of the target attributes and one of the user attributes and each of which indicates relevance of the combination is further missing, in addition to missing of the part of the evaluation values, missing of the part of the target attribute values, and missing of the part of the user attribute values; and
the training means determines the plurality of vectors so that a component which is included in the product of the plurality of vectors and which corresponds to the other of the relevance values that is not missing in the multidimensional array approximates to the other of the relevance values.

(Supplementary Note 9)

The federated learning apparatus described in Supplementary note 8, wherein the training means calculates the each of the relevance values based on a value obtained by dividing a product of one of the user attribute values and one of the target attribute values by one of the evaluation values which corresponds to the one of the user attribute values and the one of the target attribute values.

(Supplementary Note 10)

The federated learning apparatus described in any one of Supplementary notes 1 through 9, wherein the parameter information transmitting means transmits, as the first parameter information, parameter information obtained based on, among information indicating the first prediction model, information common to the first training data set and the second training data set.

(Supplementary Note 11)

The federated learning apparatus described in Supplementary note 10, wherein the information common to the first training data set and the second training data set includes information indicating a common evaluation target.

(Supplementary Note 12)

The federated learning apparatus described in Supplementary note 10 or 11, wherein the information common to the first training data set and the second training data set includes information indicating a common user.

(Supplementary Note 13)

The federated learning apparatus described in any one of Supplementary notes 10 through 12, wherein the information common to the first training data set and the second training data set includes information indicating a common target attribute.

(Supplementary Note 14)

The federated learning apparatus described in any one of Supplementary notes 10 through 13, wherein:
the first training data set further includes user attribute values each of which is possessed by one of a part or all of the users in the user list and each of which relates to one of user attributes in a user attribute list; and
the information common to the first training data set and the second training data set includes information indicating a common user attribute.

(Supplementary Note 15)

The federated learning apparatus described in any one of Supplementary notes 1 through 14, further including a predicting means for predicting the evaluation value corresponding to the combination of the user and the evaluation target with respect to which the evaluation value is not obtained, with use of the first prediction model.

(Supplementary Note 16)

A server apparatus including:
a parameter information obtaining means for obtaining a plurality of pieces of first parameter information from a respective plurality of federated learning apparatuses each of which functions as the federated learning apparatus described in any one of Supplementary notes 1 through 15;
an integrating means for generating integrated parameter information by integrating the plurality of pieces of first parameter information; and
a parameter information transmitting means for transmitting the integrated parameter information to each of the plurality of federated learning apparatuses.

(Supplementary Note 17)

A federated learning system including:
a plurality of federated learning apparatuses each of which functions as the federated learning apparatus described in any one of Supplementary notes 1 through 15; and
a server apparatus described in Supplementary note 16.

(Supplementary Note 18)

A federated learning method including:
(a) training a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list;
(b) transmitting, to a server apparatus, first parameter information which indicates at least a part of the first prediction model;
(c) obtaining, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and
(d) updating the first prediction model by replacing the first parameter information with the integrated parameter information,
(a) through (d) being carried out by a computer.

(Supplementary Note 19)

A program for causing a computer to function as:
a training means for training a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list;
a parameter information transmitting means for transmitting, to a server apparatus, first parameter information which indicates at least a part of the first prediction model;
a parameter information obtaining means for obtaining, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and
an updating means for updating the first prediction model by replacing the first parameter information with the integrated parameter information.

(Supplementary Note 20)

A recording medium in which a program is recorded,
the program causing a computer to function as:
a training means for training a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list;
a parameter information transmitting means for transmitting, to a server apparatus, first parameter information which indicates at least a part of the first prediction model;
a parameter information obtaining means for obtaining, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and
an updating means for updating the first prediction model by replacing the first parameter information with the integrated parameter information.

(Supplementary Note 21)

A federated learning method including:
(a) obtaining a plurality of pieces of first parameter information from a respective plurality of federated learning apparatuses each of which functions as the federated learning apparatus described in any one of Supplementary notes 1 through 15;
(b) generating integrated parameter information by integrating the plurality of pieces of first parameter information; and
(c) transmitting the integrated parameter information to each of the plurality of federated learning apparatuses,
(a) through (c) being carried out by a computer.

(Supplementary Note 22)

A program for causing a computer to function as:
a parameter information obtaining means for obtaining a plurality of pieces of first parameter information from a respective plurality of federated learning apparatuses each of which functions as the federated learning apparatus described in any one of Supplementary notes 1 through 15;
an integrating means for generating integrated parameter information by integrating the plurality of pieces of first parameter information; and
a parameter information transmitting means for transmitting the integrated parameter information to each of the plurality of federated learning apparatuses.

(Supplementary Note 23)

A recording medium in which a program is recorded,
the program causing a computer to function as:
a parameter information obtaining means for obtaining a plurality of pieces of first parameter information from a respective plurality of federated learning apparatuses each of which functions as the federated learning apparatus described in any one of Supplementary notes 1 through 15;
an integrating means for generating integrated parameter information by integrating the plurality of pieces of first parameter information; and
a parameter information transmitting means for transmitting the integrated parameter information to each of the plurality of federated learning apparatuses.

(Supplementary Note 24)

A federated learning method including:
(a) training a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list;
(b) transmitting, to a server apparatus, first parameter information which indicates at least a part of the first prediction model;
(c) obtaining, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and
(d) updating the first prediction model by replacing the first parameter information with the integrated parameter information,
(a) through (d) being carried out by each of a plurality of federated learning apparatuses,
the federated learning method further including:
(e) obtaining a plurality of pieces of first parameter information from the respective plurality of federated learning apparatuses;
(f) generating the integrated parameter information by integrating the plurality of pieces of first parameter information; and
(g) transmitting the integrated parameter information to each of the plurality of federated learning apparatuses,
(e) through (g) being carried out by the server apparatus.

(Supplementary Note 25)

A federated learning apparatus including
at least one processor,
the at least one processor carrying out:
a training process of training a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list;
a parameter information transmitting process of transmitting, to a server apparatus, first parameter information which indicates at least a part of the first prediction model;
a parameter information obtaining process of obtaining, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and
an updating process of updating the first prediction model by replacing the first parameter information with the integrated parameter information.

Note that this federated learning apparatus may further include a memory, and, in this memory, a program may be stored which is for causing the at least one processor to carry out the training process, the parameter information obtaining process, and the parameter information transmitting process. Alternatively, this program may be recorded in a computer-readable non-transitory tangible recording medium.

(Supplementary Note 26)

A server apparatus including
at least one processor,
the at least one processor carrying out:
a parameter information obtaining process of obtaining a plurality of pieces of first parameter information from a respective plurality of federated learning apparatuses each of which functions as the federated learning apparatus described in Supplementary note 20;
an integrating process of generating integrated parameter information by integrating the plurality of pieces of first parameter information; and
a parameter information transmitting process of transmitting the integrated parameter information to each of the plurality of federated learning apparatuses.

Note that this server apparatus may further include a memory, and, in this memory, a program may be stored which is for causing the at least one processor to carry out the parameter information obtaining process, the integrating process, and the parameter information transmitting process. Alternatively, this program may be recorded in a computer-readable non-transitory tangible recording medium.

### REFERENCE SIGNS LIST

1 Federated learning apparatus
1A, 1B, 100-i Client apparatus
2, 200 Server apparatus
300 Servicer apparatus
20 10, 10A Federated learning system
11, 111-i Training section
12, 112-i, 23, 213 Parameter information transmitting section
13, 113-i, 21, 211 Parameter information obtaining section
14, 114-i Updating section
22, 212 Integrating section
110-i, 210, 310-i Control section
120-i, 220, 320-i Storage section
130-i, 230, 330-i Communication section
311-i User registering section
312-i Commodity registering section
313-i Evaluation value registering section
314-i User ID commonality section
315-i Commonality section
316-i Federated learning requesting section
317-i Predicting section
C1 Processor
C2 Memory

1. A federated learning apparatus comprising
at least one processor,
the at least one processor carrying out:
a training process of training a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list;
a parameter information transmitting process of transmitting, to a server apparatus, first parameter information which indicates at least a part of the first prediction model;
a parameter information obtaining process of obtaining, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and
an updating process of updating the first prediction model by replacing the first parameter information with the integrated parameter information.

2. The federated learning apparatus as set forth in claim 1, wherein:
the first training data set further includes user attribute values each of which is possessed by one of a part or all of the users in the user list and each of which relates to one of user attributes in a user attribute list; and
in the training process, the at least one processor trains the first prediction model with use of the first training data set.

3. The federated learning apparatus as set forth in claim 2, wherein:
the user list included in the first training data set and the user list included in the second training data set include a mutually common user;
the evaluation target list included in the first training data set and the evaluation target list included in the second training data set include a mutually common evaluation target;
the target attribute list included in the first training data set and the target attribute list included in the second training data set include a mutually common target attribute; and
the user attribute list included in the first training data set and the user attribute list included in the second training data set include a mutually common user attribute.

4. The federated learning apparatus as set forth in claim 1, wherein:
in the training process, the at least one processor uses the first training data set as a multidimensional array in which a part of evaluation values each of which corresponds to a combination of one of the users and one of the evaluation targets is missing, and determines, as the first prediction model, a plurality of vectors obtained by decomposing the multidimensional array; and
in the parameter information transmitting process, the at least one processor transmits at least a part of the plurality of vectors as the first parameter information.

5. The federated learning apparatus as set forth in claim 4, wherein, in the training process, the at least one processor determines the plurality of vectors so that a component which is included in a product of the plurality of vectors and which corresponds to the other of the evaluation values that is not missing in the multidimensional array approximates to the other of the evaluation values.

6. The federated learning apparatus as set forth in claim 4, wherein:
in the multidimensional array, a part of target attribute values each of which corresponds to a combination of one of the target attributes and one of the evaluation targets is further missing, in addition to missing of the part of the evaluation values; and
in the training process, the at least one processor determines the plurality of vectors so that a component which is included in a product of the plurality of vectors and which corresponds to the other of the target attribute values that is not missing in the multidimensional array approximates to the other of the target attribute values.

7. The federated learning apparatus as set forth in claim 4, wherein:
the first training data set further includes user attribute values each of which is possessed by one of a part or all of the users in the user list and each of which relates to one of user attributes in a user attribute list;
in the multidimensional array, a part of user attribute values each of which corresponds to a combination of one of the user attributes and one of the users is further missing, in addition to missing of the part of the evaluation values; and
in the training process, the at least one processor determines the plurality of vectors so that a component which is included in a product of the plurality of vectors and which corresponds to the other of the user attribute values that is not missing in the multidimensional array approximates to the other of the user attribute values.

8. The federated learning apparatus as set forth in claim 7, wherein:
in the multidimensional array, a part of relevance values each of which corresponds to a combination of one of the target attributes and one of the user attributes and each of which indicates relevance of the combination is further missing, in addition to missing of the part of the evaluation values; and
in the training process, the at least one processor determines the plurality of vectors so that a component which is included in the product of the plurality of vectors and which corresponds to the other of the relevance values that is not missing in the multidimensional array approximates to the other of the relevance values.

9. The federated learning apparatus as set forth in claim 8, wherein, in the training process, the at least one processor calculates the each of the relevance values based on a value obtained by dividing a product of one of the user attribute values and one of the target attribute values by one of the evaluation values which corresponds to the one of the user attribute values and the one of the target attribute values.

10. The federated learning apparatus as set forth in claim 1, wherein, in the parameter information transmitting process, parameter information obtained based on, among information indicating the first prediction model, information common to the first training data set and the second training data set is transmitted as the first parameter information.

11. The federated learning apparatus as set forth in claim 10, wherein the information common to the first training data set and the second training data set includes information indicating a common evaluation target.

12. The federated learning apparatus as set forth in claim 10, wherein the information common to the first training data set and the second training data set includes information indicating a common user.

13. The federated learning apparatus as set forth in claim 10, wherein the information common to the first training data set and the second training data set includes information indicating a common target attribute.

14. The federated learning apparatus as set forth in claim 10, wherein:
the first training data set further includes user attribute values each of which is possessed by one of a part or all of the users in the user list and each of which relates to one of user attributes in a user attribute list; and
the information common to the first training data set and the second training data set includes information indicating a common user attribute.

15. The federated learning apparatus as set forth in claim 1, wherein the at least one processor further carries out a predicting process of predicting the evaluation value corresponding to the combination of the user and the evaluation target with respect to which the evaluation value is not obtained, with use of the first prediction model.

16. A server apparatus comprising
at least one processor,
the at least one processor carrying out:
a parameter information obtaining process of obtaining a plurality of pieces of first parameter information from a respective plurality of federated learning apparatuses each of which functions as the federated learning apparatus recited in claim 1;
an integrating process of generating integrated parameter information by integrating the plurality of pieces of first parameter information; and
a parameter information transmitting process of transmitting the integrated parameter information to each of the plurality of federated learning apparatuses.

17. A federated learning system comprising:
a plurality of federated learning apparatuses each of which functions as the federated learning apparatus recited in claim 1; and
a server apparatus,
the server apparatus including at least one processor,
the at least one processor carrying out:
a parameter information obtaining process of obtaining a plurality of pieces of first parameter information from the respective plurality of federated learning apparatuses each of which functions as the federated learning apparatus;
an integrating process of generating integrated parameter information by integrating the plurality of pieces of first parameter information; and
a parameter information transmitting process of transmitting the integrated parameter information to each of the plurality of federated learning apparatuses.

18. A federated learning method comprising:
(a) training a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list;
(b) transmitting, to a server apparatus, first parameter information which indicates at least a part of the first prediction model;
(c) obtaining, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and
(d) updating the first prediction model by replacing the first parameter information with the integrated parameter information,
(a) through (d) being carried out by a computer.

19. A non-transitory recording medium in which a program for causing a computer to operate as the federated learning apparatus recited in claim 1 is recorded, the program causing the computer to carry out the training process, the parameter information transmitting process, the parameter information obtaining process, and the updating process.

20. A federated learning method comprising:
(a) training a first prediction model that predicts an evaluation value corresponding to a combination of a user and an evaluation target with respect to which the evaluation value is not obtained, with use of a first training data set including (i) evaluation values each of which is given to one of a part or all of evaluation targets in an evaluation target list and each of which indicates evaluation by one of users in a user list and (ii) target attribute values each of which is possessed by one of a part or all of the evaluation targets in the evaluation target list and each of which relates to one of target attributes in a target attribute list;
(b) transmitting, to a server apparatus, first parameter information which indicates at least a part of the first prediction model;
(c) obtaining, from the server apparatus, integrated parameter information obtained by integrating the first parameter information and second parameter information that indicates at least a part of a second prediction model trained with use of a second training data set which is configured similarly to the first training data set and which differs from the first training data set in at least a part of the evaluation target list, the user list, the target attribute list, the evaluation values, and the target attribute values; and
(d) updating the first prediction model by replacing the first parameter information with the integrated parameter information,
(a) through (d) being carried out by each of a plurality of federated learning apparatuses,
the federated learning method further comprising:
(e) obtaining a plurality of pieces of first parameter information from the respective plurality of federated learning apparatuses;
(f) generating the integrated parameter information by integrating the plurality of pieces of first parameter information; and
(g) transmitting the integrated parameter information to each of the plurality of federated learning apparatuses,
(e) through (g) being carried out by the server apparatus.
